(19) United States
(12) Patent Application Publication
(10) Pub. No.: US 2026/0072370 A1
(43) Pub. Date: Mar. 12, 2026

(54) MAGNETIC CARRIER

(71) Applicant: CANON KABUSHIKI KAISHA, Tokyo (JP)

(72) Inventors: KOHEI YOSHIYAMA, Chiba (JP); MIZUKI SAITO, Chiba (JP); NOBUHIRO YOSHIDA, Ibaraki (JP); YUU NISHIMURA, Chiba (JP); KENTARO KAMAE, Kanagawa (JP); TORU TAKAHASHI, Ibaraki (JP); HITOSHI SANO, Chiba (JP); TAKAHO SHIBATA, Tokyo (JP)

(21) Appl. No.: 19/319,231

(22) Filed: Sep. 4, 2025

(30) Foreign Application Priority Data
Sep. 10, 2024 (JP) 2024-156490

(51) Int. Cl. G03G 9/113; G03G 9/107

(52) U.S. Cl. CPC G03G 9/1139; G03G 9/107

(57) ABSTRACT

A magnetic carrier containing a magnetic carrier particle that has a magnetic core particle and has a covering resin layer covering a surface of the magnetic core particle. The covering resin layer contains silica particles. At least part of the silica particles are exposed on the surface of the magnetic carrier particle. The arithmetic average roughness Ra of the surface of the magnetic carrier particle, the intensity of magnetization σS of the magnetic carrier in a magnetic field of 796 kA/m, the average value H of the protrusion heights of the silica particles exposed from the surface of the carrier particle, and the amount of adsorbed water M per gram of the carrier satisfy the following formulae:

$$0.3 μm \leq Ra0 \text{.60} μm \\ 45 {Am}^{2} / kg \leq σ S \leq 60 {Am}^{2} / kg \\ 25 nm \leq H \leq 100 nm \\ 0.6 mg \leq M \leq 1.1 mg$$

### BACKGROUND

### Field of the Technology

The present disclosure relates to a magnetic carrier used in an image-forming method for visualizing an electrostatic image using electrophotography.

### Description of the Related Art

High speed and high image quality are required for an electrophotographic image-forming method. To achieve high image quality, it is essential to achieve high image reproducibility in processes, such as development, transfer, and fixing.

In the electrophotographic image-forming method, a two-component development system using a two-component developer containing a magnetic carrier and a toner has been widely adopted.

The two-component development system can impart functions, such as stirring, conveyance, and charging of the developer, to the magnetic carrier and clearly separates the functions of the magnetic carrier and the toner, advantageously making it easier to control the characteristics of the developer. The magnetic carrier is typically composed of a magnetic core that imparts magnetism to ensure a conveyance property, and a covering resin formed on the magnetic core to provide charge-imparting performance to the toner.

The image reproducibility of an image formed by an electrophotographic system varies with the intensity of magnetization of a magnetic carrier. Japanese Patent Laid-Open No. 2021-193062 proposes a magnetic carrier with a reduced intensity of magnetization (saturation magnetization) and reduced variations of magnetic brushes as a carrier for an electrophotographic developer with high image reproducibility.

A developer containing a magnetic carrier and a toner is born on a developer carrier, and the layer thickness thereof is controlled to a predetermined thickness by a regulating member (hereinafter referred to as a blade). A developer born on a developer carrier is conveyed to a developing region formed between an electrostatic latent image bearing member and the developer carrier by utilizing magnetic force. On the developer carrier, the magnitude of the electrostatic force received by the toner from the electric field is different between an image area and a non-image area, and the amount of the toner remaining in the non-image area after the development step is therefore larger than that in the image area. The toner has an electric charge due to triboelectric charging, and a potential difference therefore occurs between the image area and the non-image area. When a halftone image is output immediately after an image including an image area and a non-image area is output, an uneven density (hereinafter referred to as “ghosting”) reflecting an immediately preceding image history may occur and impair image reproducibility. Japanese Patent Laid-Open No. 2022-92170 proposes a magnetic carrier with a specified apparent density or a specified surface roughness as a magnetic carrier that suppresses the ghosting.

With reference to Japanese Patent Laid-Open No. 2021-193062, the present inventors have studied a magnetic carrier with a reduced intensity of magnetization. However, it has been found that the use of a magnetic carrier with a reduced intensity of magnetization improved the image reproducibility but was likely to cause the ghosting in a high-temperature and high-humidity environment.

Thus, there is a disadvantage in achieving both improvement of image reproducibility and suppression of the ghosting.

### SUMMARY

The present disclosure provides a magnetic carrier that can suppress the ghosting in a high-temperature and high-humidity environment and achieve high image reproducibility.

The present disclosure relates to a magnetic carrier containing a magnetic carrier particle that has a magnetic core particle and has a covering resin layer covering a surface of the magnetic core particle, wherein the surface of the magnetic carrier particle has an arithmetic average roughness Ra μm) satisfying formula (1):

$$0.3 \leq Ra \leq 0.6 \qquad ( 1 )$$

the magnetic carrier has an intensity of magnetization σS (Am²/kg) in a magnetic field of 796 kA/m satisfying formula (2):

$$45 \leq σ S \leq 60 \qquad ( 2 )$$

the covering resin layer contains silica particles, and at least part of the silica particles are exposed on the surface of the magnetic carrier particle, when an average value H (nm) of protrusion heights of the silica particles exposed on the surface of the magnetic carrier particle is calculated for the silica particles exposed on the surface of the magnetic carrier particle, H satisfies formula (3):

$$25 \leq H \leq 100 \qquad ( 3 )$$

and an amount of adsorbed water M (mg) per gram of the magnetic carrier at a temperature of 30° C. and at a relative humidity of 80% satisfies formula (4):

$$0.6 \leq M \leq 1.1 . \qquad ( 4 )$$

Features of the present disclosure will become apparent from the following description of embodiments with reference to the attached drawings. The following description of embodiments is described by way of example.

### BRIEF DESCRIPTION OF THE DRAWINGS

FIG. 1 is a surface observation image of a magnetic carrier taken with SEM.

FIG. 2 is a schematic view of a method for measuring the protrusion height of a silica particle exposed on the surface of a magnetic carrier particle.

FIG. 3 is a schematic view of surface treatment apparatus for performing surface treatment of toner.

FIG. 4 is a schematic view of a test chart composed of a solid portion and a solid white portion for evaluation of the ghosting.

FIG. 5 is a schematic view of a test chart composed of a full-surface halftone image area for evaluation of the ghosting.

### DESCRIPTION OF THE EMBODIMENTS

The phrase “XX or more and YY or less” or “XX to YY” indicating a numerical range, as used herein, refers to a numerical range including end points, the lower limit and the upper limit, unless otherwise specified. For stepwise numerical ranges, the upper limit and the lower limit of each numerical range may be arbitrarily combined.

A developer is coated on a developer carrier to a predetermined layer thickness using a blade in a development unit. Toner deposited on the developer carrier is scraped off by frictional sliding with a magnetic carrier blocked by the blade. When the magnetic carrier has a low intensity of magnetization, the magnetic force acting between the magnetic carrier and the developer carrier decreases, the frictional sliding force also decreases, and the toner is therefore likely to remain on the developer carrier and causes the ghosting. Furthermore, in a high-temperature and high-humidity environment, a decrease in the charge amount of the toner results in a decrease in the electric field driving force during development, and the force by which the toner on the developer carrier is attracted to the surface of the developer carrier due to the image force becomes stronger. Thus, the toner remains on the surface of the developer carrier in a larger amount in a non-image area with a weak electric field than in an image area, thus causing the ghosting. The present inventors further changed the surface roughness of a magnetic carrier with reference to Japanese Patent Laid-Open No. 2022-92170 but found that the ghosting cannot be sufficiently suppressed.

As described above, a magnetic carrier with a reduced intensity of magnetization can improve the image reproducibility, whereas the force of scraping off toner on a developer carrier by a blade in a development unit decreases.

The present inventors have studied a means that can scrape off a toner on a developer carrier in a high-temperature and high-humidity environment even when a magnetic carrier with a reduced intensity of magnetization is used. More specifically, the present inventors conducted studies under the premise that forming an uneven surface profile on a surface of a magnetic carrier could facilitate scraping off toner. As a result, the toner scraping force was improved, but the ghosting in a high-temperature and high-humidity environment was not sufficiently suppressed. This is probably because the uneven surface profile on the surface of the magnetic carrier increased the contact area between the magnetic carrier and the toner, but the toner could not be sufficiently scraped off due to small adhesion strength between the magnetic carrier and the toner.

The present inventors have focused on liquid cross-linking via water as a means for improving the adhesion strength between a magnetic carrier and toner. When the hydrophilicity of the entire surface of a magnetic carrier is enhanced to increase the amount of water adsorbed on the surface of the magnetic carrier, however, the magnetic carrier cannot stably provide an electric charge to toner, and the image reproducibility deteriorates. Thus, the present inventors considered that both suppression of the ghosting in a high-temperature and high-humidity environment and high image reproducibility can be achieved by exposing water-absorbing fine particles on the surface of a magnetic carrier to locally increase the hydrophilicity of the surface of a magnetic carrier particle. As a result of extensive studies, the present inventors have found that the above can be achieved when a magnetic carrier has the following configuration.

A magnetic carrier in the present disclosure is a magnetic carrier containing a magnetic carrier particle that has a magnetic core particle and has a covering resin layer covering a surface of the magnetic core particle, wherein a surface of the magnetic carrier particle has an arithmetic average roughness Ra (μm) satisfying formula (1):

$$0.3 \leq Ra \leq 0.6 \qquad ( 1 )$$

the magnetic carrier has an intensity of magnetization σS (Am²/kg) in a magnetic field of 796 kA/m satisfying formula (2):

$$45 \leq σ S \leq 60 \qquad ( 2 )$$

the covering resin layer contains silica particles, and at least part of the silica particles are exposed on the surface of the magnetic carrier particle, when an average value H (nm) of protrusion heights of the silica particles exposed on the surface of the magnetic carrier particle is calculated for the silica particles exposed on the surface of the magnetic carrier particle, H satisfies formula (3):

$$25 \leq H \leq 100 \qquad ( 3 )$$

and an amount of adsorbed water M (mg) per gram of the magnetic carrier at a temperature of 30° C. and at a relative humidity of 80% satisfies formula (4):

$$0.6 \leq M \leq 1.1 . \qquad ( 4 )$$

The present inventors presume the following mechanism as to how both the suppression of the ghosting in a high-temperature and high-humidity environment and high image reproducibility are achieved.

The silica particles are exposed on the particle surface of the magnetic carrier and therefore adsorb water in a high-temperature and high-humidity environment. The contact between the exposed silica particles and the toner generates a liquid cross-linking force via water. When the arithmetic average roughness of the surface of the magnetic carrier particle and the protrusion height of the exposed silica particles satisfy the above ranges, the contact area and the adhesion strength between the magnetic carrier and the toner are increased. Consequently, even when the magnetic carrier has a low intensity of magnetization, the toner on the developer carrier can be scraped off, and both the suppression of the ghosting and the high image reproducibility can be achieved.

Each requirement of the present disclosure will be described in detail below.

The arithmetic average roughness Ra (μm) of the surface of the magnetic carrier particle needs to satisfy the following formula (1) to scrape off the toner on the developer carrier.

$$0.3 \leq Ra \leq 0.6 \qquad ( 1 )$$

When Ra is 0.30 μm or more, the toner on the developer carrier can be scraped off by protrusions on the surface of the magnetic carrier particle. When Ra is 0.60 μm or less, the magnetic carrier particle and the toner are easily brought into contact with each other, and the toner on the developer carrier can be scraped off. Ra is preferably 0.35≤Ra≤0.55, more preferably 0.40≤Ra≤0.50. The arithmetic average roughness of the magnetic carrier particle can be controlled by the calcination temperature of a magnetic carrier core, the type and amount of a covering resin, and the like.

The intensity of magnetization σS (Am²/kg) of the magnetic carrier needs to satisfy the following formula (2) to improve the image reproducibility and scrape off the toner on the developer carrier. The term “intensity of magnetization σS (Am²/kg)”, as used herein, refers to the intensity of magnetization in a magnetic field of 796 kA/m.

$$45 \leq σ S \leq 60 \qquad ( 2 )$$

When σS is 45 Am²/kg or more, a magnetic binding force for scraping off the toner on the developer carrier is obtained. When OS is 60 Am²/kg or less, variations of magnetic brushes of the magnetic carrier can be suppressed, and high image reproducibility can be achieved. OS is preferably 48≤σS≤57, more preferably 50≤σS≤55. The intensity of magnetization of the magnetic carrier can be controlled by changing the component ratio of a metal oxide as a raw material and the oxygen concentration in the atmosphere during calcination.

To scrape off the toner on the developer carrier, it is necessary that a covering resin layer covering the surface of the magnetic core particle contains silica particles, at least part of the silica particles are exposed on the surface of the magnetic carrier particle, and the average value H (nm) of the protrusion heights of the silica particles exposed on the surface of the magnetic carrier particle satisfies the following formula (3).

$$25 \leq H \leq 100 \qquad ( 3 )$$

When H is 25 nm or more, the silica particles easily adsorb water. Then, the silica particles and the toner easily come into contact with each other, a liquid cross-linking force acts between the silica particles and the toner, and the toner on the developer carrier can be scraped off. When H is 100 nm or less, the liquid cross-linking force between the silica particles and the toner appropriately acts to reduce the amount of the toner remaining on the surface of the magnetic carrier after the development step. This results in an increase in the exposed area of the surface of the magnetic carrier particle, and the toner on the developer carrier can be scraped off. H is preferably 35≤H≤85, more preferably 40≤H≤80. The average value of the protrusion heights of the silica particles can be controlled by changing the coating conditions and the coating step at the time of applying a covering resin.

To scrape off the toner on the developer carrier, it is necessary that the amount of adsorbed water M (mg) per gram of the magnetic carrier at a temperature of 30° C. and at a relative humidity of 80% satisfies the following formula (4).

$$0.6 \leq M \leq 1.1 . \qquad ( 4 )$$

When M is 0.60 mg or more, a liquid cross-linking force acts between carrier particles and the toner, and the toner on the developer carrier can be scraped off. When M is 1.10 mg or less, the toner can be appropriately charged even in a high-temperature and high-humidity environment, and the amount of toner remaining on the surface of the magnetic carrier after the development step is reduced. This results in an increase in the exposed area of the surface of the magnetic carrier particle, and the toner on the developer carrier can be scraped off. M is preferably 0.70≤M≤1.00, more preferably 0.75≤M≤0.90. The amount of adsorbed water per gram of the magnetic carrier can be controlled by changing the hydrophobization ratio of silica particles described later or the coverage of the surface of the magnetic carrier particle with silica particles exposed on the surface of the magnetic carrier particle.

The coverage A (% by area) of the surface of the magnetic carrier particle with silica particles preferably satisfies the following formula (5) from the perspective of scraping off the toner on the developer carrier.

$$10 \leq A \leq 30 \qquad ( 5 )$$

A is preferably 10% by area or more because a region where a liquid cross-linking force acts between the magnetic carrier and the toner on the surface of the magnetic carrier particle becomes large, and the toner on the developer carrier is easily scraped off. A is preferably 30% by area or less because the toner can be appropriately charged, the amount of toner remaining on the surface of the magnetic carrier after the development step is reduced, and the toner on the developer carrier is easily scraped off. A is preferably 12≤A≤25, more preferably 14≤A≤20. The coverage can be controlled by changing the number of parts of silica particles added to the covering resin.

The number-average particle diameter rA (nm) of the silica particles exposed on the surface of the magnetic carrier particle preferably satisfies the following formula (6) from the perspective of scraping off the toner on the developer carrier.

$$50 \leq rA \leq 250 \qquad ( 6 )$$

rA is preferably 50 nm or more because the silica particles can be sufficiently exposed on the surface of the magnetic carrier particle, a liquid cross-linking force acts between the silica particles and the toner, and the toner on the developer carrier is easily scraped off. rA is preferably 250 nm or less because the silica particles are sufficiently stuck to the surface of the magnetic carrier particle, a liquid cross-linking force acts between the silica particles and the toner, and the toner on the developer carrier is easily scraped off. rA is preferably 60≤rA≤230, more preferably 80≤rA≤200.

H (nm) and A (% by area) in a magnetic carrier of the present disclosure preferably satisfy the following formula (7) from the perspective of scraping off toner on a developer carrier.

$$2.3 \leq H / A \leq 6. \qquad ( 7 )$$

H/A is preferably 2.30 (nm/% by area) or more because a region where a liquid cross-linking force acts between the silica particles and the toner becomes large, and the toner on the developer carrier is easily scraped off. H/A is preferably 6.00 (nm/% by area) or less because the magnetic carrier appropriately adsorbs water, and the toner can therefore be appropriately charged even in a high-temperature and high-humidity environment. H/A is preferably 3.00≤H/A≤5.00, more preferably 3.50≤H/A≤4.50.

rA (nm) and A (% by area) in a magnetic carrier of the present disclosure preferably satisfy the following formula (8) from the perspective of scraping off the toner on the developer carrier.

$$4. \leq rA / A \leq 15. \qquad ( 8 )$$

rA/A is preferably 4.00 (nm/% by area) or more because the magnetic carrier appropriately adsorbs water, and the toner can therefore be appropriately charged even in a high-temperature and high-humidity environment. rA/A is preferably 15.00 (nm/% by area) or less because a region where a liquid cross-linking force acts between the silica particles and the toner becomes large, and the toner on the developer carrier is easily scraped off. rA/A is preferably 5.00≤rA/A≤13.00, more preferably 6.00≤rA/A≤11.00.

The hydrophobization ratio W (%) of silica particles in a magnetic carrier of the present disclosure preferably satisfies the following formula (9) from the perspective of scraping off the toner on the developer carrier.

$$95 \leq W \leq 98 \qquad ( 9 )$$

W is preferably 95% or more because the toner can be appropriately charged even in a high-temperature and high-humidity environment. W is preferably 98% or less because the silica particles easily adsorb water, a liquid cross-linking force acts between the silica particles and the toner, and the toner on the developer carrier is easily scraped off. W is preferably 96%≤W≤98%. The hydrophobization ratio of silica particles can be controlled by changing the type and amount of surface treatment agent.

Each constituent will be described below.

### Magnetic Carrier

A magnetic carrier (hereinafter also referred to simply as a “carrier”) in the present disclosure has a magnetic core particle and a covering resin layer covering the surface of the magnetic core particle. The covering resin layer contains silica particles, and at least part of the silica particles are exposed on the surface of a magnetic carrier particle. The surface of the magnetic carrier has an arithmetic average roughness in a specific range.

### Magnetic Core Particle

The magnetic core particle of the magnetic carrier can be a known magnetic particle, such as ferrite or magnetite. A magnetic core particle in a form of a ferrite or magnetite particle including a pore filled with a resin can also be used.

Among these, a magnetic core in a form of a magnetic particle including a pore filled with a resin is preferable from the perspective of reducing the amount of magnetization of the magnetic carrier. Furthermore, the component ratio of a metal oxide as a raw material can be changed to prepare ferrite with a desired amount of magnetization.

A resin to be contained in a pore of a porous magnetic particle may be, but is not limited to, a copolymer resin used as a covering resin and may be a known resin, such as a thermoplastic resin or a thermosetting resin.

The thermoplastic resin is preferably a copolymer used as a covering resin, and other examples thereof include the following. Polystyrene, poly(methyl methacrylate), a styrene-acrylate copolymer, a styrene-methacrylate copolymer, a styrene-butadiene copolymer, an ethylene-vinyl acetate copolymer, poly(vinyl chloride), poly(vinyl acetate), a poly(vinylidene difluoride) resin, a fluorocarbon resin, a perfluorocarbon resin, a solvent-soluble perfluorocarbon resin, polyvinylpyrrolidone, a petroleum resin, a novolac resin, a saturated alkyl polyester resin, an aromatic polyester resin, such as poly(ethylene terephthalate), poly(butylene terephthalate), or polyarylate, a polyamide resin, a polyacetal resin, a polycarbonate resin, a poly(ether sulfone) resin, a polysulfone resin, a poly(phenylene sulfide) resin, or a poly(ether ketone) resin.

Examples of the thermosetting resin include the following. A phenolic resin, a modified phenolic resin, a maleic resin, an alkyd resin, an epoxy resin, an acrylic resin, an unsaturated polyester produced by polycondensation of maleic anhydride, terephthalic acid, and a polyhydric alcohol, a urea resin, a melamine resin, a urea-melamine resin, a xylene resin, a toluene resin, a guanamine resin, a melamine-guanamine resin, an acetoguanamine resin, a Glyptal resin, a furan resin, a silicone resin, polyimide, a polyamideimide resin, a poly(ether imide) resin, or a polyurethane resin.

The magnetic core particle preferably has a 50% particle diameter (D50) of 20 μm or more and 80 μm or less on a volume distribution basis from the perspectives of uniformly applying the covering resin, preventing adhesion of the magnetic carrier, and optimizing the density of magnetic brushes to achieve high image reproducibility.

### Covering Resin Layer

A magnetic carrier of the present disclosure contains a covering resin layer covering the surface of a magnetic core particle. The covering resin layer contains a covering resin and silica particles.

The covering resin may be a homopolymer of styrene and a substitution product thereof, such as poly-p-chlorostyrene or polyvinyltoluene; a styrene copolymer, such as a styrene-p-chlorostyrene copolymer, a styrene-vinyltoluene copolymer, a styrene-vinylnaphthalene copolymer, a styrene-acrylate copolymer, or a styrene-methacrylate copolymer; or a styrene copolymer resin, a (meth)acrylic resin, a silicone resin, a polyester resin, a styrene-acrylic resin, a urethane resin, polyethylene, poly(ethylene terephthalate), a polystyrene resin, a polyamide resin, a polypropylene resin, or another resin.

The covering resin may also be a resin with a reactive functional group. The reactive functional group can be selected from known functional groups, such as a carboxy group, a hydroxy group, an epoxy group, an amino group, a vinyl group, a (meth)acryloyl group, an isocyanate group, a mercapto group, and an oxazoline group. More specifically, the resin with a carboxy group may be a resin produced by polymerizing acrylic acid, methacrylic acid, or itaconic acid as a monomer, the resin with a hydroxy group may be a resin composed of 3-hydroxymethylacryl, 2-hydroxyethylacrylic acid, 2-hydroxypropylacrylic acid, 2-hydroxypropylmethacrylic acid, 2-hydroxybutylacrylic acid, or the like, the resin with a vinyl group may be a resin composed of allyl acrylate, allyl methacrylate, or the like, the resin with an epoxy group may be a resin composed of glycidyl acrylate, hydroxybutyl glycidyl ether acrylate, or β-(3,4-epoxycyclohexyl)ethyltrimethoxysilane, and the resin with an amine may be a resin composed of acrylamide or methacrylamide.

### Silica Particles

A magnetic carrier of the present disclosure contains silica particles in a covering resin layer. The silica particles are not particularly limited and can be selected from known silica particles without losing the advantages of the present disclosure. Examples thereof include combustion silica particles, deflagration silica particles, sol-gel silica particles, precipitation silica particles, and colloidal silica particles. Among these, wet silica particles produced by a wet method, such as a sol-gel method or a precipitation method, are preferred because water is easily adsorbed in a high-temperature and high-humidity environment and a liquid cross-linking force acts between the silica particles and toner.

The silica particles are preferably subjected to hydrophobic treatment by surface treatment. Any known means can be used for the surface treatment and can be selected from a silane coupling agent, a titanate coupling agent, an aluminate coupling agent, or the like with an alkyl group, such as a methyl group, an ethyl group, or a propyl group, and silica particles with a desired hydrophobization ratio can be produced. Among these, a silane coupling agent can be particularly suitably used, and the hexamethyldisilazane treatment is a particularly suitable form because the silica particles appropriately adsorb water in a high-temperature and high-humidity environment and a liquid cross-linking force acts easily.

The shape of the silica particles is preferably, but not limited to, a spherical shape because the contact area with toner increases and a liquid cross-linking force acts easily. The silica particles preferably have a number-average particle diameter of 50 nm or more and 250 nm or less to stick to the surface of a magnetic carrier particle and to be sufficiently exposed to the surface of the magnetic carrier particle.

### Toner

A magnetic carrier in the present disclosure can be used in combination with a toner produced by a known method without any particular limitation. It is typically composed mainly of a binder resin for a toner base and optionally contains a release agent, a colorant, a dispersing aid, and inorganic particles.

### Binder Resin for Toner Base

The binder resin for the toner base in toner can be the following polymer. A homopolymer of styrene or a substitution product thereof, such as polystyrene, poly-p-chlorostyrene, or polyvinyltoluene; a styrene copolymer, such as a styrene-p-chlorostyrene copolymer, a styrene-vinyltoluene copolymer, a styrene-vinylnaphthalene copolymer, a styrene-acrylate copolymer, or a styrene-methacrylate copolymer; a styrene copolymer resin, a polyester resin, or a hybrid resin in which a polyester resin and a vinyl resin are mixed or both are partially reacted; poly(vinyl chloride), a phenolic resin, a natural modified phenolic resin, a natural resin modified maleic acid resin, an acrylic resin, a methacrylic resin, poly(vinyl acetate), a silicone resin, a polyester resin, polyurethane, a polyamide resin, a furan resin, an epoxy resin, a xylene resin, a polyethylene resin, a polypropylene resin, or the like. Among these, a polyester resin is preferably used as a main component from the perspective of low-temperature fixability.

A monomer used for a polyester unit of a polyester resin may be a polyhydric alcohol (an alcohol with a valence of 2, 3, or more), a polycarboxylic acid (a carboxylic acid with a valence of 2, 3, or more), an acid anhydride thereof, or a lower alkyl ester thereof. Here, partial cross-linking in the molecule of an amorphous resin is effective in preparing a branched polymer to develop a “strain hardening property”, and for this purpose, a polyfunctional compound with a valence of 3 or more is preferably used. Thus, a carboxylic acid with a valence of 3 or more, an acid anhydride thereof, a lower alkyl ester thereof, and/or an alcohol with a valence of 3 or more is preferably contained as a raw material monomer of the polyester unit.

The polyhydric alcohol monomers used for the polyester unit of the polyester resin may be the following polyhydric alcohol monomers.

The alcohol component with a valence of 2 may be ethylene glycol, propylene glycol, 1,3-butanediol, 1,4-butanediol, 2,3-butanediol, diethylene glycol, triethylene glycol, 1,5-pentanediol, 1,6-hexanediol, neopentyl glycol, 2-ethyl-1,3-hexanediol, hydrogenated bisphenol A, a bisphenol represented by the formula (A), or a derivative thereof;

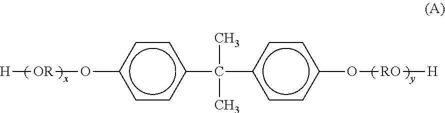

(In the formula (A), R denotes an ethylene or propylene group, x and y each denote an integer of 0 or more, and the average value of x+y is 0 or more and 10 or less.)
or a diol represented by the formula (B).

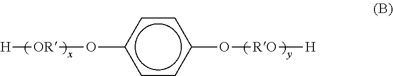

(In the formula (B), R′ denotes —CH₂—CH₂—, —CH₂—CH(—CH₃)—, or —CH₂—C(—CH₃)₂—, x′ and y′ denote an integer of 0 or more, and the average value of x′+y′ ranges from 0 to 10.)

The alcohol component with a valence of 3 or more may be sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, 2-methylpropanetriol, 2-methyl-1,2,4-butanetriol, trimethylolethane, trimethylolpropane, or 1,3,5-trihydroxymethylbenzene. Among these, glycerol, trimethylolpropane, and pentaerythritol are preferably used. These alcohols with a valence of 2 and alcohols with a valence of 3 or more may be used alone or in combination.

The polycarboxylic acid monomers used for the polyester unit of the polyester resin may be the following polycarboxylic acid monomers.

The carboxylic acid component with a valence of 2 is, for example, maleic acid, fumaric acid, citraconic acid, itaconic acid, glutaconic acid, phthalic acid, isophthalic acid, terephthalic acid, succinic acid, adipic acid, sebacic acid, azelaic acid, malonic acid, n-dodecenylsuccinic acid, isododecenylsuccinic acid, n-dodecylsuccinic acid, isododecylsuccinic acid, n-octenylsuccinic acid, n-octylsuccinic acid, isooctenylsuccinic acid, isooctylsuccinic acid, an anhydride thereof, or a lower alkyl ester thereof. Among these, maleic acid, fumaric acid, terephthalic acid, and n-dodecenylsuccinic acid are preferably used.

The carboxylic acid with a valence of 3 or more, an acid anhydride thereof, or a lower alkyl ester thereof is, for example, 1,2,4-benzenetricarboxylic acid, 2,5,7-naphthalenetricarboxylic acid, 1,2,4-naphthalenetricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexanetricarboxylic acid, tetra(methylenecarboxyl) methane, 1,2,7,8-octanetetracarboxylic acid, pyromellitic acid, Empol trimer acid, an acid anhydride thereof, or a lower alkyl ester thereof. Among these, 1,2,4-benzenetricarboxylic acid, that is, trimellitic acid, or a derivative thereof is particularly preferably used because of its low cost and easy reaction control. These carboxylic acids with a valence of 2 and carboxylic acids with a valence of 3 or more may be used alone or in combination.

The polyester unit can be produced by any method and can be produced by a known method. For example, the alcohol monomer and the carboxylic acid monomer described above are charged at the same time and are polymerized through an esterification reaction or a transesterification reaction and a condensation reaction to produce a polyester resin. Furthermore, the polymerization temperature is preferably, but not limited to, 180° C. or more and 290° C. or less. In the polymerization of the polyester unit, for example, a polymerization catalyst, such as a titanium-based catalyst, a tin-based catalyst, zinc acetate, antimony trioxide, or germanium dioxide, can be used. In particular, the binder resin for the toner base is more preferably a polyester unit polymerized using a tin-based catalyst.

The polyester resin preferably has an acid value of 5 mgKOH/g or more and 20 mgKOH/g or less and a hydroxyl value of 20 mgKOH/g or more and 70 mgKOH/g or less from the perspective of fogging because the amount of water adsorption in a high-temperature and high-humidity environment can be suppressed and non-electrostatic adhesion force can be kept low.

The binder resin for the toner base may be a mixture of a low-molecular-weight resin and a high-molecular-weight resin. The ratio of the high-molecular-weight resin content to the low-molecular-weight resin content is preferably 40/60 or more and 85/15 or less on a mass basis from the perspective of low-temperature fixability and hot offset resistance.

### Release Agent

A toner may contain a release agent to improve separability from a member during heat fixing. Examples thereof include the following. A hydrocarbon wax, such as a low-molecular-weight polyethylene, a low-molecular-weight polypropylene, an alkylene copolymer, a microcrystalline wax, a paraffin wax, or a Fischer-Tropsch wax; an oxide of a hydrocarbon wax, such as an oxidized polyethylene wax, or a block copolymer thereof; a wax composed mainly of a fatty acid ester, such as carnauba wax; or a partially or completely deacidified fatty acid ester, such as deacidified carnauba wax. Further examples include the following. A saturated straight-chain fatty acid, such as palmitic acid, stearic acid, or montanic acid; an unsaturated fatty acid, such as brassidic acid, eleostearic acid, or parinaric acid; a saturated alcohol, such as stearyl alcohol, aralkyl alcohol, behenyl alcohol, carnaubyl alcohol, ceryl alcohol, or myricyl alcohol; a polyhydric alcohol, such as sorbitol; an ester of a fatty acid, such as palmitic acid, stearic acid, behenic acid, or montanic acid, and an alcohol, such as stearyl alcohol, aralkyl alcohol, behenyl alcohol, carnaubyl alcohol, ceryl alcohol, or myricyl alcohol; a fatty acid amide, such as linolcamide, oleamide, or lauramide; a saturated fatty acid bisamide, such as methylenebisstearamide, ethylenebiscapramide, ethylenebislauramide, or hexamethylenebisstearamide; an unsaturated fatty acid amide, such as ethylenebisoleamide, hexamethylenebisoleamide, N,N′-dioleyl adipamide, or N,N′-dioleyl sebacamide; an aromatic bisamide, such as m-xylenebisstearamide or N,N′-distearyl isophthalamide; an aliphatic metal salt (generally referred to as a metallic soap), such as calcium stearate, calcium laurate, zinc stearate, or magnesium stearate; a wax produced by grafting a vinyl monomer, such as styrene or acrylic acid, onto an aliphatic hydrocarbon wax; a partially esterified compound of a fatty acid and a polyhydric alcohol, such as behenic acid monoglyceride; or a methyl ester compound with a hydroxy group produced by hydrogenation of vegetable fats and oils.

Among these waxes, a hydrocarbon wax, such as a paraffin wax or a Fischer-Tropsch wax, or a fatty acid ester wax, such as carnauba wax, is preferable from the perspective of improving low-temperature fixability and fixing separability. In the present disclosure, a hydrocarbon wax is more preferable from the perspective of further improving hot offset resistance. In the present disclosure, the wax is preferably used in an amount of 3 parts by mass or more and 8 parts by mass or less per 100 parts by mass of a binder resin for a toner base.

The peak temperature of the maximum endothermic peak of the wax is preferably 45° C. or more and 140° C. or less in an endothermic curve during heating measured with a differential scanning calorimetry (DSC) apparatus. The peak temperature of the maximum endothermic peak of the wax in the above range is preferred because both storage stability and hot offset resistance of toner can be achieved.

### Colorant

Toner particles may contain a colorant. Examples of the colorant include the following.

Examples of a black colorant include carbon black; and colorants toned to black using a yellow colorant, a magenta colorant, and a cyan colorant. The colorant may be a pigment alone but is preferably a combination of a dye and a pigment to improve definition from the perspective of the image quality of a full-color image.

Examples of a pigment for a magenta toner include the following. C. I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48:2, 48:3, 48:4, 49, 50, 51, 52, 53, 54, 55, 57:1, 58, 60, 63, 64, 68, 81:1, 83, 87, 88, 89, 90, 112, 114, 122, 123, 146, 147, 150, 163, 184, 202, 206, 207, 209, 238, 269, or 282; C. I. Pigment Violet 19; or C. I. Vat Red 1, 2, 10, 13, 15, 23, 29, or 35.

Examples of a dye for a magenta toner include the following. C. I. Solvent Red 1, 3, 8, 23, 24, 25, 27, 30, 49, 81, 82, 83, 84, 100, 109, or 121; C. I. Disperse Red 9; C. I. Solvent Violet 8, 13, 14, 21, or 27; an oil-soluble dye, such as C. I. Disperse Violet 1, or a basic dye, such as C. I. Basic Red 1, 2, 9, 12, 13, 14, 15, 17, 18, 22, 23, 24, 27, 29, 32, 34, 35, 36, 37, 38, 39, or 40; or C. I. Basic Violet 1, 3, 7, 10, 14, 15, 21, 25, 26, 27, or 28.

Examples of a pigment for a cyan toner include the following. C. I. Pigment Blue 2, 3, 15:2, 15:3, 15:4, 16, or 17; C. I. Vat Blue 6; C. I. Acid Blue 45, or a copper phthalocyanine pigment with a phthalocyanine skeleton substituted with 1 to 5 phthalimidomethyl groups.

A dye for a cyan toner may be C. I. Solvent Blue 70.

Examples of a pigment for a yellow toner include the following. C. I. Pigment Yellow 1, 2, 3, 4, 5, 6, 7, 10, 11, 12, 13, 14, 15, 16, 17, 23, 62, 65, 73, 74, 83, 93, 94, 95, 97, 109, 110, 111, 120, 127, 128, 129, 147, 151, 154, 155, 168, 174, 175, 176, 180, 181, or 185; or C. I. Vat Yellow 1, 3, 20.

A dye for a yellow toner may be C. I. Solvent Yellow 162.

These colorants may be used alone or in combination and may be used in the form of solid solution. The colorant is selected in terms of hue angle, color saturation, lightness value, light fastness, OHP transparency, and dispersibility in toner.

The colorant content is preferably 0.1 parts by mass or more and 30.0 parts by mass or less based on the total amount of resin components in toner.

### Dispersing Aid

Toner particles preferably contain a dispersing aid to disperse a release agent in the resin. The dispersing aid may be a known dispersing aid, and when a hydrocarbon wax is contained as a release agent, a polymer with a structure formed by reacting a vinyl resin component and a hydrocarbon compound is preferably contained to disperse the wax in the resin. In particular, it is preferable to contain a graft polymer in which a vinyl monomer is graft-polymerized to a polyolefin.

A polymer, if contained in the dispersing aid, enhances the compatibility between the wax and the resin and suppresses adverse effects, such as charging failure and soiling of the member, due to poor dispersion of the wax. The dispersing aid content is preferably 1.0 part by mass or more and 15 parts by mass or less per 100 parts by mass of a binder resin for a toner base. When the dispersing aid content is within this range, the dispersed state of wax in an amorphous resin tends to be uniform. The polyolefin may be any polymer or copolymer of an unsaturated hydrocarbon, and various polyolefins can be used. In particular, polyethylene or polypropylene is preferably used. A plurality of these may be used.

Examples of a monomer with a vinyl group include the following.

A styrene unit, such as styrene or a derivative thereof, such as styrene, o-methylstyrene, m-methylstyrene, p-methylstyrene, p-methoxystyrene, p-phenylstyrene, p-chlorostyrene, 3,4-dichlorostyrene, p-ethylstyrene, 2,4-dimethylstyrene, p-n-butylstyrene, p-tert-butylstyrene, p-n-hexylstyrene, p-n-octylstyrene, p-n-nonylstyrene, p-n-decylstyrene, or p-n-dodecylstyrene.

An α-methylene aliphatic monocarboxylate with an amino group, such as dimethylaminoethyl methacrylate or diethylaminoethyl methacrylate; or a vinyl unit containing a N atom, such as an acrylic acid or methacrylic acid derivative, such as acrylonitrile, methacrylonitrile, or acrylamide.

An unsaturated dibasic acid, such as maleic acid, citraconic acid, itaconic acid, an alkenylsuccinic acid, fumaric acid, or mesaconic acid; an unsaturated dibasic acid anhydride, such as maleic anhydride, citraconic anhydride, itaconic anhydride, or an alkenylsuccinic anhydride; an unsaturated dibasic acid half ester, such as a methyl maleate half ester, an ethyl maleate half ester, a butyl maleate half ester, a methyl citraconate half ester, an ethyl citraconate half ester, a butyl citraconate half ester, a methyl itaconate half ester, a methyl alkenylsuccinate half ester, a methyl fumarate half ester, or a methyl mesaconate half ester; an unsaturated dibasic acid ester, such as dimethyl maleate or dimethyl fumarate; an α,β-unsaturated acid, such as acrylic acid, methacrylic acid, crotonic acid, or cinnamic acid; an α,β-unsaturated acid anhydride, such as crotonic anhydride or cinnamic anhydride, or an anhydride of the α,β-unsaturated acid and a lower fatty acid; or a vinyl unit with a carboxy group, such as an alkenylmalonic acid, an alkenylglutaric acid, or an alkenyladipic acid, or an acid anhydride or a monoester thereof.

An acrylate or methacrylate, such as 2-hydroxyethyl acrylate, 2-hydroxyethyl methacrylate, or 2-hydroxypropyl methacrylate, or a vinyl unit with a hydroxy group, such as 4-(1-hydroxy-1-methylbutyl) styrene or 4-(1-hydroxy-1-methylhexyl) styrene.

An ester unit composed of an acrylate, such as methyl acrylate, ethyl acrylate, n-butyl acrylate, isobutyl acrylate, propyl acrylate, n-octyl acrylate, dodecyl acrylate, 2-ethylhexyl acrylate, stearyl acrylate, 2-chloroethyl acrylate, or phenyl acrylate.

An ester unit composed of a methacrylate, such as an a-methylene aliphatic monocarboxylate, such as cyclohexyl methacrylate, methyl methacrylate, ethyl methacrylate, propyl methacrylate, n-butyl methacrylate, isobutyl methacrylate, n-octyl methacrylate, dodecyl methacrylate, 2-ethylhexyl methacrylate, stearyl methacrylate, phenyl methacrylate, dimethylaminoethyl methacrylate, or diethylaminocthyl methacrylate. A plurality of these may be used.

The dispersing aid can be produced by a known method, such as a reaction between these polymers or a reaction between a monomer of one polymer and the other polymer.

### Fine Inorganic Particles

Fine inorganic particles are preferably externally added to toner for the purpose of improving flowability and chargeability.

A spacer particle for suppressing blocking of toner is preferably an external additive of silica particles with a maximum peak particle diameter of 50 nm or more and 200 nm or less on a number distribution basis. The external additive of silica particles is more preferably 80 nm or more and 150 nm or less from the perspective of a function as spacer particles and suppression of detachment from the toner.

Furthermore, to improve the flowability of toner, fine inorganic particles with a maximum peak particle diameter of 20 nm or more and 50 nm or less on a number distribution basis are preferably contained and, in a preferable embodiment, are combined with the spacer particles.

From the perspective of improving the liquid cross-linking force acting between a magnetic carrier and toner, the external additive of silica particles is preferably the same as silica particles exposed on the surface of a magnetic carrier particle.

Furthermore, another external additive may be added to toner for the purpose of improving flowability and transferability. The external additive to be externally added to toner preferably contains fine inorganic particles, such as titanium oxide, aluminum oxide, strontium titanate, or barium titanate, and a plurality of types thereof may be used in combination.

The total external additive content of toner is preferably 0.3 parts by mass or more and 5.0 parts by mass or less, more preferably 0.8 parts by mass or more and 4.0 parts by mass or less, per 100 parts by mass of toner particles. The amount of the external additive of silica particles with a maximum peak particle diameter of 80 nm or more and 200 nm or less on a number distribution basis is preferably 0.1 parts by mass or more and 2.5 parts by mass or less, more preferably 0.5 parts by mass or more and 2.0 parts by mass or less. Within this range, the effects as a spacer particle become more remarkable.

Furthermore, the surface of the external additive of silica particles or the fine inorganic particles used as the external additive is preferably subjected to a hydrophobic treatment. The hydrophobic treatment is preferably performed using a coupling agent, such as a titanate coupling agent or a silane coupling agent; a fatty acid or a metal salt thereof; a silicone oil; or a combination thereof.

The hydrophobic treatment is preferably performed by adding a hydrophobic treatment agent to particles to be treated in an amount of 1% or more by mass and 30% or less by mass (more preferably 3% or more by mass and 7% or less by mass) with respect to the particles to be treated to cover the particles to be treated with the hydrophobic treatment agent.

The degree of hydrophobization of the external additive subjected to the hydrophobic treatment is not particularly limited; for example, the hydrophobization ratio (%) of the external additive is preferably 40% or more and 98% or less.

### Method for Producing Toner

Toner particles may be produced by any method, including a known method, such as a pulverization method, a suspension polymerization method, a dissolution suspension method, an emulsion aggregation method, or a dispersion polymerization method. Among them, the pulverization method is preferable from the perspective of controlling wax on the surface of the toner particles. Thus, the toner particles are preferably pulverized toner particles.

A procedure for producing toner particles by the pulverization method will be described below.

In a raw material mixing step, as materials constituting toner particles, for example, a binder resin, a release agent, a colorant, a crystalline polyester, and another optional component, such as a charge control agent, are weighed in predetermined amounts, blended, and mixed. A mixing apparatus is, for example, a double cone mixer (manufactured by Nishimura Machine Works Co., Ltd.), a V-type mixer (manufactured by Nishimura Machine Works Co., Ltd.), a drum-type mixer (manufactured by Eishin Co., Ltd.), Super Mixer (manufactured by Kawata Mfg. Co., Ltd.), a Henschel mixer (manufactured by Nippon Coke & Engineering Co., Ltd.), a Nauta mixer (manufactured by Hosokawa Micron Corporation), Mechano Hybrid (manufactured by Nippon Coke & Engineering Co., Ltd.), or the like.

The mixed materials are then melt-kneaded to disperse wax and the like in the binder resin. In the melt-kneading step, a batch kneader, such as a pressure kneader or a Banbury mixer, or a continuous kneader can be used, and a single-screw or twin-screw extruder is mainly used because of its advantage of continuous production. Examples thereof include a KTK type twin-screw extruder (manufactured by Kobe Steel, Ltd.), a TEM type twin-screw extruder (manufactured by Toshiba Machine Co., Ltd.), a PCM kneader (manufactured by Ikegai Corporation), a twin-screw extruder (manufactured by KCK), a co-kneader (manufactured by Buss AG), and Kneadex (manufactured by Nippon Coke & Engineering Co., Ltd.). Furthermore, a resin composition prepared by melt-kneading may be rolled with a two-roll mill or the like and may be cooled with water or the like in a cooling step.

The cooled resin composition is then pulverized to a desired particle diameter in a pulverization step. In the pulverization step, coarse pulverization is performed, for example, with a pulverizer, such as a crusher, a hammer mill, or a feather mill, and fine pulverization is then further performed, for example, with a Kryptron system (manufactured by Kawasaki Heavy Industries, Ltd.), Super Rotor (manufactured by Nisshin Engineering Inc.), a turbo mill (manufactured by Turbo Kogyo Co., Ltd.), or an air jet pulverizer.

Subsequently, if necessary, classification is performed with a classifier or a sifter, such as an inertial classification type Elbow-Jet (manufactured by Nittetsu Mining Co., Ltd.), a centrifugal classification type Turboplex (manufactured by Hosokawa Micron Corporation), a TSP separator (manufactured by Hosokawa Micron Corporation), or Faculty (manufactured by Hosokawa Micron Corporation).

Fine inorganic particles, such as fine silica particles, are then externally added to the surfaces of the toner particles to produce a toner. The fine inorganic particles may be externally added by a method of blending the classified toner and known fine inorganic particles in predetermined amounts, followed by stirring and mixing using, as an external addition apparatus, a mixing apparatus, such as a double cone mixer (manufactured by Nishimura Machine Works Co., Ltd.), a V-type mixer (manufactured by Nishimura Machine Works Co., Ltd.), a drum-type mixer (manufactured by Eishin Co., Ltd.), Super Mixer (manufactured by Kawata Mfg. Co., Ltd.), a Henschel mixer (manufactured by Nippon Coke & Engineering Co., Ltd.), a Nauta mixer (manufactured by Hosokawa Micron Corporation), Mechano Hybrid (manufactured by Nippon Coke & Engineering Co., Ltd.), or Nobilta (manufactured by Hosokawa Micron Corporation).

### Method for Producing Magnetic Carrier

A magnetic carrier is produced by a different method depending on its type.

As an example, a process of producing porous magnetic particles will be described in detail below.

### Method for Producing Magnetic Core Particle

### Step 1 Weighing and Mixing Step

First, raw materials of ferrite are weighed and mixed.

Ferrite is a sintered body represented by the following general formula.

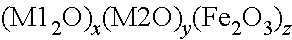

In the formula, M1 denotes a monovalent metal, M2 denotes a divalent metal, and when x+y+z=1.0, x and y are each 0≤(x, y)≤0.8, and z is 0.2<z<1.0.

In the formula, M1 and M2 are preferably at least one metal atom selected from the group consisting of Li, Fe, Mn, Mg, Sr, Cu, Zn, and Ca. Furthermore, Ni, Co, Ba, Y, V, Bi, In, Ta, Zr, B, Mo, Na, Sn, Ti, Cr, Al, Si, a rare earth, or the like can also be used.

Examples of a ferrite raw material include metal particles of the above-described metal element, or an oxide, hydroxide, oxalate, carbonate, or the like thereof. Examples of the mixing apparatus include the following. A ball mill, a planetary mill, a Giotto mill, or a vibrating mill. In particular, a ball mill is preferable from the perspective of mixability. More specifically, a weighed ferrite raw material, together with balls, is placed in a ball mill and is pulverized and mixed preferably for 0.1 hours or more and 20.0 hours or less.

### Step 2 Preliminary Calcination Step

The pulverized and mixed ferrite raw material is preliminarily calcined to be ferritized in the atmosphere or in a nitrogen atmosphere preferably at a calcination temperature of 700° C. or more and 1200° C. or less preferably for 0.5 hours or more and 5.0 hours or less. For the calcination, for example, the following furnace is used. Examples thereof include a burner incinerator, a rotary furnace, and an electric furnace.

### Step 3 Pulverization Step

The pre-calcined ferrite produced in the step 2 is pulverized with a pulverizer. The pulverizer is not particularly limited as long as a desired particle diameter is achieved. Examples thereof include the following. Examples thereof include a crusher, a hammer mill, a ball mill, a bead mill, a planetary mill, and a Giotto mill. To produce pulverized ferrite with a desired particle diameter, for example, in a ball mill or a bead mill, it is preferable to control the material and particle diameter of balls or beads to be used and the operation time. More specifically, to reduce the particle diameter of pre-calcined ferrite slurry, balls with a high specific gravity may be used, or the pulverization time may be increased. To broaden the particle size distribution of the pre-calcined ferrite, balls or beads with a high specific gravity may be used, and the pulverization time may be shortened. It is also possible to produce a pre-calcined ferrite with a wide distribution by mixing a plurality of pre-calcined ferrites with different particle diameters. Furthermore, in a ball mill or a bead mill, a wet method has a higher pulverization efficiency than a dry method because a pulverized product does not scatter in the mill. Thus, the wet method is more preferable than the dry method.

### Step 4 Granulation Step

Water, a binder, and, if necessary, a pore adjusting agent are added to the pulverized product of the pre-calcined ferrite. The pore adjusting agent may be a foaming agent or fine resin particles. The foaming agent is, for example, sodium hydrogen carbonate, potassium hydrogen carbonate, lithium hydrogen carbonate, ammonium hydrogen carbonate, sodium carbonate, potassium carbonate, lithium carbonate, or ammonium carbonate.

The binder is, for example, poly(vinyl alcohol).

The fine resin particles are, for example, fine particles of a polyester, a polystyrene, or a styrene copolymer, such as a styrene-vinyltoluene copolymer, a styrene-vinylnaphthalene copolymer, a styrene-acrylate copolymer, a styrene-methacrylate copolymer, a styrene-α-methyl chloromethacrylate copolymer, a styrene-acrylonitrile copolymer, a styrene-vinyl methyl ketone copolymer, a styrene-butadiene copolymer, a styrene-isoprene copolymer, or a styrene-acrylonitrile-indene copolymer; poly(vinyl chloride), a phenolic resin, a modified phenolic resin, a maleic resin, an acrylic resin, a methacrylic resin, poly(vinyl acetate), or a silicone resin; a polyester resin having, as a structural unit, a monomer selected from an aliphatic polyhydric alcohol, an aliphatic dicarboxylic acid, an aromatic dicarboxylic acid, an aromatic dialcohol, and a diphenol; or a polyurethane resin, a polyamide resin, poly(vinyl butyral), a terpene resin, a coumarone-indene resin, a petroleum resin, or a hybrid resin with a polyester unit and a vinyl polymer unit.

When wet pulverization is performed in the step 3, it is preferable to add a binder and, if necessary, a pore adjusting agent in consideration of water contained in ferrite slurry.

The resulting ferrite slurry is dried and granulated using a spray dryer preferably in a heated atmosphere of 100° C. or more and 200° C. or less. The spray dryer is not particularly limited as long as porous magnetic particles with a desired particle diameter can be produced. For example, a spray dryer can be used.

### Step 5 Main Calcination Step

The granulated product is then calcined preferably at 800° C. or more and 1400° C. or less preferably for 1 hour or more and 24 hours or less. The calcination temperature and the calcination time can be increased to promote the calcination of porous magnetic core particles and consequently reduce the pore diameter and the number of pores.

### Step 6 Sorting Step

After the particles calcined as described above are crushed, if necessary, coarse particles and fine particles may be removed by classification or sieving with a sieve.

### Step 7 Filling Step

The method for filling the voids of the porous magnetic core particles with a resin is not particularly limited and may be a method of impregnating the porous magnetic core particles with a resin solution by an application method, such as a dipping method, a spraying method, a brushing method, or a fluidized bed, and then volatilizing the solvent. It is also possible to employ a method of diluting a resin with a solvent and adding this to the voids of the porous magnetic core particles.

The solvent used here may be any solvent that can dissolve the resin. For a resin soluble in an organic solvent, the organic solvent may be toluene, xylene, cellosolve butyl acetate, methyl ethyl ketone, methyl isobutyl ketone, or methanol. For a water-soluble resin or an emulsion-type resin, the solvent may be water.

The resin solid content of the resin solution is preferably 1% or more by mass and 50% or less by mass, more preferably 1% or more by mass and 30% or less by mass. When the content is 50% or less by mass, the viscosity is not too high, and the resin solution easily permeates uniformly into the voids of the porous magnetic core particles. On the other hand, when the content is 1% or more by mass, the amount of the resin is appropriate, and the adhesion strength of the resin to the porous magnetic core particles is improved. Subsequently, the method for covering the surface of each magnetic core particle with the resin may be, but is not limited to, an application method, such as a dipping method, a spraying method, a brushing method, a dry method, or a fluidized bed.

### Method for Applying Covering Resin

The method of covering the surface of a magnetic core particle with a covering resin may be, but is not limited to, a known method. One example is a so-called dipping method of, while stirring the magnetic core particle and a covering resin solution, volatilizing the solvent to cover the surface of the magnetic core particle with the covering resin. Specific examples thereof include a universal mixer (manufactured by Fuji Paudal Co., Ltd.), a Nauta mixer (manufactured by Hosokawa Micron Corporation), and a vacuum degassing kneader. There is also a method of spraying a covering resin solution from a spray nozzle while forming a fluidized bed to cover the surface of the magnetic core particle with the covering resin. Specific examples thereof include Spira Cota (manufactured by Okada Seiko Co., Ltd.) and Spir-A-Flow (manufactured by Freund Corporation). A magnetic carrier core may be covered in a dry process with the covering resin in the form of particles. Specific examples thereof include a treatment method using an apparatus, such as a hybridizer (manufactured by Nara Machinery Co., Ltd.), Mechanofusion (manufactured by Hosokawa Micron Corporation), High Flex Gral (manufactured by Fukac Powtec Corporation), or Theta Composer (manufactured by Tokuju Corporation).

### Method for Producing Two-Component Developer

A two-component developer contains a toner and a magnetic carrier. More specifically, it is produced by mixing the toner and the magnetic carrier. For mixing, a typical mixing apparatus can be used. Examples thereof include a double cone mixer (manufactured by Nishimura Machine Works Co., Ltd.), a V-type mixer (manufactured by Nishimura Machine Works Co., Ltd.), a drum-type mixer (manufactured by Eishin Co., Ltd.), Super Mixer (manufactured by Kawata Mfg. Co., Ltd.), a Henschel mixer (manufactured by Nippon Coke & Engineering Co., Ltd.), and a Nauta mixer (manufactured by Hosokawa Micron Corporation). Such an apparatus can be used to uniformly mix the toner and the carrier and improve the mixability of a developer for replenishment and a developer in a development unit.

When the toner is mixed with the magnetic carrier, the mixing ratio of the carrier is preferably 2% or more by mass and 15% or less by mass, more preferably 4% or more by mass and 13% or less by mass, as the toner concentration in the two-component developer. Within this range, fogging and toner scattering can be satisfactorily suppressed.

Method for Separating Magnetic Core Particle from Carrier

100 mL of methyl isobutyl ketone was added to 10 g of a carrier, and ultrasonic cleaning was performed at an output of 60 kHz for 15 minutes. After only a solid component was separated using a filter paper with a particle retention specification of 7 um, an operation of adding 100 mL of toluene again and performing the same washing and filtration was additionally repeated twice. The resulting solid was completely dried with a vacuum dryer to produce magnetic core particles.

Method for Separating Silica Particles from Carrier

10 mL of methyl isobutyl ketone was added to 10 g of a carrier, and ultrasonic cleaning was performed at an output of 60 kHz for 15 minutes. After a liquid phase was recovered by decantation, an operation of adding 10 mL of toluene again and performing the same washing and recovery of the liquid phase was additionally repeated twice. All of the recovered liquid phases were combined, and a magnetic material was completely removed using a permanent magnet.

The resulting liquid phase was charged into a centrifugal separator and was rotated at 15,000 rpm for 2 hours to separate a solid component. 20 mL of tetrahydrofuran was added to the solid component, and ultrasonic waves were applied to dissolve or disperse all the solid components in the liquid. The liquid was charged into a centrifugal separator and was rotated at 15,000 rpm for 2 hours to separate a solid component, and the solid component was completely dried using a vacuum dryer. The same procedure of tetrahydrofuran addition, centrifugation, and drying was repeated twice on the solid component, which was then dried under vacuum at 120° C. for 24 hours to produce silica particles.

Measurement of Number-Average Particle Diameter of Silica Particles Separated from Carrier

First, 5.0 g of Triton-X 100 (manufactured by Kishida Chemical Co., Ltd.) was added to 95.0 g of RO water to prepare a 5% aqueous Triton-X 100 (hereinafter referred to as a 5% Triton solution). 0.2 g of the 5% Triton solution and 19.8 g of RO water were added to 10 mg of the dried silica particles to prepare a solution. A probe (a front edge of a front edge) of an ultrasonic disperser was immersed in the solution, and ultrasonic dispersion was performed at an output of 20 W for 15 minutes to prepare a dispersion liquid. The number-average particle diameter (nm) was then measured using this dispersion liquid and using a dynamic light scattering (DLS) particle size distribution analyzer (trade name: Nanotrac 150, manufactured by MicrotracBEL Corp.).
Mode: transmission
Particle condition: spherical
Particle refractive index: 1.45
Particle density: 1.30
Refractive index of dispersion medium: 1.33 (water)
Measurement time: 120 seconds
   Method for Separating Covering Resin from Carrier

10 mL of methyl isobutyl ketone was added to 10 g of a carrier, and ultrasonic cleaning was performed at an output of 60 kHz for 15 minutes. After a liquid phase was recovered by decantation, an operation of adding 10 mL of toluene again and performing the same washing and recovery of the liquid phase was additionally repeated twice. All of the recovered liquid phases were combined, and a magnetic material was completely removed using a permanent magnet.

The resulting liquid phase was charged into a centrifugal separator and was rotated at 15,000 rpm for 2 hours to separate a solid component. An operation of concentrating the liquid phase by removing the solvent under reduced pressure until the volume of the solution became approximately 1 mL, adding 15 mL of n-hexane, filtering off a precipitated solid component with a filter paper with a particle retention specification of 1 μm, and washing the solid component with 15 mL of n-hexane was repeated three times. The resulting solid component was completely dried with a vacuum dryer to produce a covering resin.

### Measurement of Arithmetic Average Roughness Ra of Magnetic Carrier

The magnetic carrier is placed on a specimen plate to select particles with a particle diameter within 50% average particle diameter±10% on a volume distribution basis of the magnetic carrier.

A roughness curve is measured for 4 μm of the particle surface of the magnetic carrier using a violet color laser microscope (manufactured by Keyence Corporation, model name “VK-9500”). The measurement is performed under the conditions of a lens magnification of 150 times, an optical zoom of 20 times, a pitch of 0.05 μm, and a cut-off curvature of 0.08 mm or more to determine the arithmetic average roughness Ra using three-dimensional surface shape analysis software (manufactured by Mitani Corporation, trade name “SurftopEye”).

Ra is determined for 100 magnetic carrier particles to adopt the average value thereof as Ra in the present disclosure.

Measurement of Intensity of Magnetization σS of Magnetic Carrier in Magnetic Field of 796 kA/m

The intensity of magnetization σS in an external magnetic field of 796 kA/m (10 kOe) was determined with an oscillating magnetic field type magnetic property automatic recording apparatus BHV-30 manufactured by Riken Denshi Co., Ltd. A measurement sample of a magnetic carrier is prepared in a state of being packed in a cylindrical plastic container so as to be sufficiently dense. The magnetization moment is measured in this state, and the actual mass of the specimen filled as described above is measured to determine the intensity of magnetization σS (Am²/kg).

Method for Measuring Coverage A of Surface of Magnetic Carrier Particle with Silica Particles Exposed on Surface of Magnetic Carrier Particle

The coverage A in the present disclosure was measured by analyzing a secondary electron image of a scanning electron microscope.

The secondary electron image was taken with a scanning electron microscope SU8220 (manufactured by Hitachi High-Tech Corporation). More specifically, magnetic carrier particles were fixed on a sample stage for electron microscopic observation with a carbon tape so as to form a single layer, were subjected to a flushing operation, and were then observed. The observation conditions are as described below.

$$Signal Name = SE ( U ) \\ Accelerating Voltage = 800 V \\ Working Distance = 8 , 000 μm \\ Emission Current = 10 , 000 nA \\ Lens Mode = High \\ Condenser 1 = 5 , 000 \\ Scan Speed = slow 3 \\ Color Mode = Gray scale \\ Data Size = 1280 \times 960 \\ Magnification = 25 , 000$$

In the measurement of the secondary electron image, the contrast and the brightness were set to 60 and −15, respectively, on the control software, and the image was acquired so that a resin layer as flat as possible was captured at the central portion and the contrast derived from the surface profile was as small as possible. At this time, image regions showing a resin layer portion and a silica particle portion in the visual field can be distinguished by using EDX observation in combination.

The coverage of the surface of a magnetic carrier particle with silica particles exposed on the surface of the magnetic carrier particle was calculated by analyzing the secondary electron image. More specifically, the image was subjected to binarization processing using a programming language “Python” and extended libraries “OpenCV” and “NumPy” to calculate the number of pixels with a brightness value of 255. The detailed procedure is as described below.

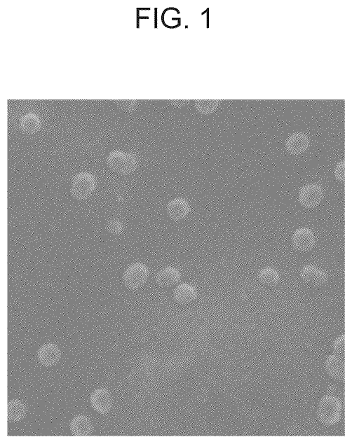

First, a 400 pixels×400 pixels region was trimmed from part of the image. At this time, an image range that included only a covering resin and silica particles, that was as smooth as possible, and that had a small contrast due to concavities and convexities was selected with the naked eye of the observer. FIG. 1 shows an example of the image at this time. A median blur process as shown in the conditional expression (1) was then performed to remove noise. In the conditional expression (1), “img” is a variable indicating an input image.

$$cv 2. medianBlur ( img , ksize = 9 ) \qquad conditional expression ( 1 )$$

Furthermore, the image after noise reduction was binarized so as to be an image including only pixels with a brightness value of 0 and pixels with a brightness value of 255. In this process, the condition shown in the conditional expression (2) was used. In the conditional expression (2), “img” is a variable indicating an image after the median blur process.

$$cv 2. threshold ( ig , 0 , 255 , cv 2. THRESH\_OTSU ) \qquad conditional expression ( 2 )$$

For the binarized image, the number of pixels with a brightness value of 255 was calculated and divided by 160,000, which is the number of pixels included in the 400 pixels×400 pixels region, to calculate the coverage of the carrier surface with the silica particles. The condition used at this time is shown in the conditional expression (3). In the conditional expression (3), “img” is a variable indicating an image after the binarization process.

$$( img / 255 ) . sum ( ) / 160000 * 100 \qquad conditional expression ( 3 )$$

The above operation was performed on 50 particles, and the arithmetic mean of 30 numerical values excluding the numerical values corresponding to the 1st to 10th particles and the numerical values corresponding to the 41st to 50th particles when the particles were arranged in order of coverage was defined as the coverage A (% by area) of the surface of the magnetic carrier particle with silica particles.

### Measurement of Protrusion Height of Silica Particle Exposed on Surface of Magnetic Carrier Particle

A cross section of a magnetic carrier particle is observed with a transmission electron microscope (TEM) to measure the protrusion height of a silica particle exposed on the surface of the magnetic carrier particle.

First, a magnetic carrier particle is subjected to ion milling using an argon ion milling apparatus (manufactured by Hitachi High-Tech Corporation, trade name: E-3500) to expose a cross section of the magnetic carrier particle. The ion milling measurement conditions are as described below.
Beam diameter: 400 μm (half width)
Ion gun accelerating voltage: 5 kV
Ion gun discharge voltage: 4 kV
Ion gun discharge current: 463 μA

Next, the cross section of the magnetic carrier particle is observed with a transmission electron microscope (manufactured by JEOL Ltd., trade name: JEM-2800) (TEM-EDX) at a magnification of 50,000 times in a visual field in which the outermost surface of the magnetic carrier particle can be observed. At this time, a cross-sectional portion of a covering resin layer and a cross-sectional portion of a silica particle on the outermost surface of the magnetic carrier particle in the visual field can be distinguished by using EDX observation in combination. The cross-sectional area of the silica particle is determined from an image of the observed cross section of the silica particle to determine the diameter of a circle with an area equal to the cross-sectional area (circle-equivalent diameter). An image of a cross section of a silica particle with a circle-equivalent diameter within ±10% of the number-average particle diameter of silica particles separated from the magnetic carrier particle is used for the measurement.

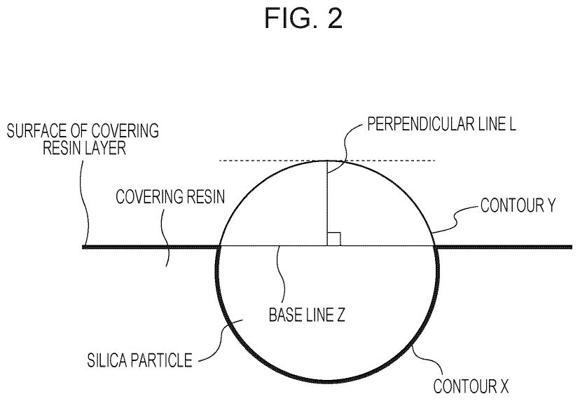

FIG. 2 is a schematic view illustrating a method for measuring the protrusion height of a silica particle exposed on the surface of a magnetic carrier particle. In the contour of the silica particle in the observed image, the contour of the silica particle in contact with a covering resin layer is defined as a contour X, and the contour of the silica particle other than the contour X is defined as a contour Y. The silica particle with the contour X and the contour Y is determined as a silica particle exposed on the surface of the magnetic carrier particle and is used as an object to be measured. For the silica particle to be measured, the end points of the contour X are connected by a straight line to define a base line Z. Among the perpendicular lines connecting the base line Z and the contour Y, a perpendicular line L with the maximum length is defined, and the length of the perpendicular line L is measured.

The perpendicular lines L of 100 silica particles exposed on the surface of the magnetic carrier particle are measured by the above procedure. The arithmetic mean of the 100 measured values was taken as the protrusion height H (nm).

### Measurement of Amount of Adsorbed Water M of Magnetic Carrier

The amount of adsorbed water of a magnetic carrier was measured with a thermogravimetric analyzer Q5000 (manufactured by TA Instruments). The measurement conditions are as described below.
Sample Pan: Metallized Quartz
Gas 1: Nitrogen
Gas 2: Nitrogen
Balance Gas: Nitrogen 10.0 ml/min
Humidity Gas: Nitrogen 200.0 ml/min

The amount of adsorbed water of a magnetic carrier was measured by the following procedure.
1: 30 mg of the magnetic carrier is weighed in a sample pan.
2: The sample pan is set in a chamber, and the environment in the chamber is adjusted to a temperature of 23.00° C. and a relative humidity of 5.00% and is held for 5 hours.
3: The environment in the chamber is changed to a temperature of 30.00° C. and a relative humidity of 80.00% and is held for 5 hours. The weight of the magnetic carrier is then measured for 5 minutes. The weight is measured once every four seconds. The arithmetic mean of the measured values (75 measurements) is defined as M1 (mg).
4: The environment in the chamber is changed to a temperature of 23.00° C. and a relative humidity of 5.00% and is held for 5 hours. The weight of the magnetic carrier is then measured for 5 minutes. The weight is measured once every four seconds. The arithmetic mean of the measured values (75 measurements) is defined as M2 (mg).

The amount of adsorbed water M (mg) per gram of the magnetic carrier was calculated using the following formula from M1 and M2 obtained in the measurement. Amount of adsorbed water M (mg) per gram of magnetic carrier=(M1−M2)/M2

### Method for Measuring Number-Average Particle Diameter rA of Silica Particles Exposed on Surface of Magnetic Carrier Particle

A cross section of a magnetic carrier particle is observed with a transmission electron microscope (TEM) to measure the number-average particle diameter of silica particles exposed on the surface of the magnetic carrier particle.

The cross section of the magnetic carrier particle is taken in the same manner as in the measurement of the protrusion heights of the silica particles exposed on the surface of the magnetic carrier particle described above.

The cross section of the magnetic carrier particle is then observed with a transmission electron microscope (manufactured by JEOL Ltd., trade name: JEM-2800) (TEM-EDX) at a magnification of 50,000 times in a visual field in which the outermost surface of the magnetic carrier particle can be observed. At this time, a cross-sectional portion of a covering resin layer and a cross-sectional portion of a silica particle on the outermost surface of the magnetic carrier particle in the visual field can be distinguished by using EDX observation in combination. The cross-sectional area of the silica particle is determined from an image of the observed cross section of the silica particle to determine the diameter of a circle with an area equal to the cross-sectional area (circle-equivalent diameter). An image of a cross section of a silica particle with a circle-equivalent diameter within ±10% of the number-average particle diameter of silica particles separated from the magnetic carrier particle is used for the measurement.

In the observed image, a silica particle with the contour X and the contour Y described above is identified. The cross-sectional area of the silica particle is determined from an image of the identified silica particle to determine the diameter of a circle with an area equal to the cross-sectional area (circle-equivalent diameter).

The circle-equivalent diameters of 100 silica particles exposed on the surface of the magnetic carrier particle are measured by the above procedure. The arithmetic mean of the values of the 100 circle-equivalent diameters was taken as the number-average particle diameter rA (nm).

### Measurement of Hydrophobization Ratio W of Silica Particles

The hydrophobization ratio of silica particles is calculated by methanol titrimetry. More specifically, the measurement is performed by the following procedure. In a liquid mixture of 0.5 g of silica particles in 50 ml of RO water, methanol is added dropwise from a burette while stirring the liquid mixture until all of the silica particles are wetted. Whether or not all of the silica particles are wetted is determined by whether or not all silica particles floating on the water surface are submerged in the liquid and are suspended in the liquid. At this time, the percentage of the amount (ml) of methanol added dropwise relative to the total amount (ml) of the RO water and the methanol added dropwise at the time of completion of the dropwise addition is defined as a hydrophobization ratio W (%). A higher hydrophobization ratio indicates a higher hydrophobicity.

### Method for Measuring 50% Diameter (D50) on Volume Distribution Basis of Magnetic Carrier

The particle size distribution was measured with a laser diffraction-scattering particle size distribution analyzer “Microtrac MT3300EX” (manufactured by Nikkiso Co., Ltd.).

The 50% diameter (D50) on a volume distribution basis of a magnetic carrier was measured with a sample feeder for dry measurement “one-shot dry type sample conditioner Turbotrac” (manufactured by Nikkiso Co., Ltd.). As the feed conditions of Turbotrac, a dust collector was used as a vacuum source, the air flow was approximately 33 L/s, and the pressure was approximately 17 kPa. The control is automatically performed by associated software (version 10.3.3-202D), and the analysis is also performed using the same software. The measurement conditions are as described below.
SetZero time: 10 seconds
Measurement time: 10 seconds
Number of measurements: 1
Refractive index of particle: 1.81
Particle shape: non-spherical
Upper limit of measurement: 1408 μm
Lower limit of measurement: 0.243 μm
Measurement environment: temperature of 23° C., relative humidity of 50%

### Exemplary Embodiments

The present disclosure will be described in detail below with reference to exemplary embodiments and comparative examples. The materials, additives, use amounts and concentrations, treatment methods, and procedures described below can be appropriately modified without departing from the gist of the present disclosure, and the embodiments of the present disclosure should not be construed as being limited by the contents of the exemplary embodiments.

In the following description, “%” and “parts” are based on mass unless otherwise specified.

### Production Example of Resin A

Polyoxypropylene (2.2)-2,2-bis(4-hydroxyphenyl) propane: 76.3 parts
Terephthalic acid: 16.1 parts
Succinic acid: 7.6 parts
Titanium tetrabutoxide (esterification catalyst): 0.5 parts

These materials were added to a reaction vessel equipped with a cooling tube, a stirrer, a nitrogen inlet tube, and a thermocouple. The reaction vessel was then purged with nitrogen gas and was gradually heated while stirring to perform a reaction at a temperature of 200° C. for 4 hours while stirring. Furthermore, the pressure in the reaction vessel was lowered to 8.3 kPa, was maintained for 1 hour, and was returned to the atmospheric pressure after cooling to 160° C. (a first reacting step).
Tert-butylcatechol (polymerization inhibitor): 0.1 parts

This material was then added, the pressure in the reaction vessel was lowered to 8.3 kPa, a reaction was carried out for 1 hour while maintaining the temperature at 180° C., and after confirming that the softening point measured in accordance with ASTM D36-86 reached a temperature of 90° C., the temperature was lowered to stop the reaction (a second reaction step), thus preparing a resin A. The resin A had a peak molecular weight Mp of 4500, a softening point Tm of 90° C., and a glass transition temperature Tg of 54° C.

### Production Example of Resin B

Polyoxypropylene (2.2)-2,2-bis(4-hydroxyphenyl) propane: 74.8 parts
Terephthalic acid: 12.9 parts
Adipic acid: 7.9 parts
Titanium tetrabutoxide (esterification catalyst): 0.5 parts

These materials were weighed in a reaction vessel equipped with a cooling tube, a stirrer, a nitrogen inlet tube, and a thermocouple. The reaction vessel was then purged with nitrogen gas and was gradually heated while stirring to perform a reaction at a temperature of 200° C. for 2 hours while stirring. Furthermore, the pressure in the reaction vessel was lowered to 8.3 kPa, was maintained for 1 hour, and was returned to the atmospheric pressure after cooling to 160° C. (a first reacting step).
Trimellitic acid: 5.9 parts
Tert-butylcatechol (polymerization inhibitor): 0.1 parts

These materials were then added, the pressure in the reaction vessel was lowered to 8.3 kPa, a reaction was carried out for 15 hours while maintaining the temperature at 200° C., and after confirming that the softening point measured in accordance with ASTM D36-86 reached a temperature of 140° C., the temperature was lowered to stop the reaction (a second reaction step), thus preparing a resin B. The resin B had a peak molecular weight Mp of 10,000, a softening point Tm of 140° C., and a glass transition temperature Tg of 60° C.

### Production Example of Resin C

1,6-hexanediol: 33.9 parts
Dodecanedioic acid: 66.1 parts

These materials were weighed in a reaction vessel equipped with a cooling tube, a stirrer, a nitrogen inlet tube, and a thermocouple. The reaction vessel was then purged with nitrogen gas and was gradually heated while stirring to perform a reaction at a temperature of 140° C. for 3 hours while stirring.
Stannous 2-ethylhexanoate: 0.5 parts

This material was then added, the pressure in the reaction vessel was lowered to 8.3 kPa, and a reaction was carried out for 4 hours while maintaining the temperature at 200° C., thus preparing a resin C (a first reaction step). The resin C had a weight-average molecular weight Mw of 11,000 and a melt peak temperature Tp of 72° C.

### Production Example of Dispersant D

Low-molecular-weight polypropylene (Viscol 660P manufactured by Sanyo Chemical Industries, Ltd.): 10.0 parts
Xylene: 25.0 parts

These materials were weighed in a reaction vessel equipped with a cooling tube, a stirrer, a nitrogen inlet tube, and a thermocouple. The reaction vessel was then purged with nitrogen gas and was gradually heated to 175° C. while stirring.
Styrene: 65.0 parts
Cyclohexyl acrylate: 5.5 parts
Butyl acrylate: 12.5 parts
Methacrylic acid: 5.5 parts
Xylene: 10.0 parts
Di-t-butylperoxyhexahydroterephthalate: 0.5 parts

These materials were then added dropwise over 3 hours and were then stirred for 30 minutes. The solvent was then distilled off to prepare a dispersant D in which a styrene acrylic polymer was graft-polymerized to a polyolefin. The dispersant D had a peak molecular weight Mp of 6,000 and a softening point Tm of 125° C.

### Production Example of Toner 1

Resin A: 62 parts
Resin B: 28 parts
Resin C: 10 parts
Dispersant D: 4 parts
Fischer-Tropsch wax (peak temperature of maximum endothermic peak: 90° C.): 4 parts
C. I. Pigment Blue 15:3: 7 parts

These materials were mixed in a Henschel mixer (FM-75 type, manufactured by Mitsui Mining Co., Ltd.) at a number of rotation of 20 s⁻¹ for a rotation time of 5 min and were then kneaded with a twin-screw kneader (PCM-30 type, manufactured by Ikegai Corporation) set at a temperature of 130° C. The kneaded product was cooled and coarsely pulverized to 1 mm or less with a hammer mill to prepare a coarsely pulverized product. The coarsely pulverized product was finely pulverized with a mechanical grinder (T-250, manufactured by Turbo Kogyo Co., Ltd.). Furthermore, classification was performed with Faculty (F-300, manufactured by Hosokawa Micron Corporation) to prepare toner particles. As the operating conditions of Faculty, the number of rotation of a classifying rotor was 130 s⁻¹, and the number of rotation of a dispersing rotor was 120 s⁻¹.

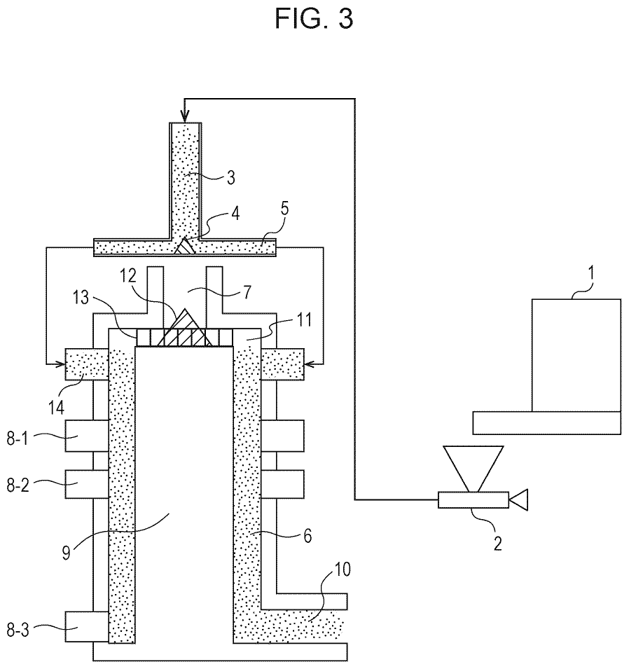

The toner particles were subjected to a heat treatment by a surface treatment apparatus illustrated in FIG. 3 (for details of each part of the apparatus, see Japanese Patent Laid-Open No. 2021-189367) to prepare heat-treated toner particles. The operating conditions were as follows: feed rate=5 kg/h, hot air temperature=160° C., hot air flow rate=6 m³/min, cool air temperature=−5° C., cool air flow rate=4 m³/min, blower air flow=20 m³/min, and injection air flow rate=1 m³/min.

100 parts of the heat-treated toner particles were mixed with 1.0 part of hydrophobic silica particles (BET: 200 m²/g) and 1.0 part of fine titanium oxide particles (BET: 80 m²/g) surface-treated with isobutyltrimethoxysilane in a Henschel mixer (FM-75 type, manufactured by Mitsui Miike Machinery Co., Ltd.) at a number of rotation of 30 s⁻¹ for a rotation time of 10 min to prepare a toner 1.

The toner had a weight-average particle diameter (D4) of 6.3 μm as measured with “CDA-1000X” (aperture size: 100 μm, manufactured by Sysmex Corporation). The toner had an average circularity of 0.967 as measured with a flow particle image analyzer “FPIA-3000” (manufactured by SYSMEX Corporation).

### Production Example of Silica Particles 1

100 parts of methanol and 16 parts of 15% aqueous ammonia were added to a glass reaction vessel equipped with a stirrer and two dropping apparatuses, and the resulting liquid mixture was stirred in a nitrogen stream at 35° C. at a rotational speed of 150 rpm. Tetramethoxysilane and 5.4% aqueous ammonia were simultaneously added dropwise thereto. Tetramethoxysilane was added dropwise at 31.1 parts/hour for 6 hours, and 5.4% aqueous ammonia was added dropwise at 13.4 parts/hour for 5 hours. After the dropwise addition, stirring was performed for 10 minutes while maintaining the temperature, thereby preparing a dispersion liquid of raw silica particles.

The raw silica particles were recovered from the dispersion liquid of raw silica particles by suction filtration and were then heated and dried in an oven at 400° C. for 10 minutes to prepare raw silica particles.

100 parts of the raw silica particles were charged into an autoclave, and the autoclave was purged with nitrogen. While stirring the raw silica particles in the autoclave, 0.7 parts of hexamethyldisilazane and 0.2 parts of distilled water atomized by a two-fluid nozzle were sprayed thereto. The autoclave was sealed, was stirred for 30 minutes, and was then heated at 200° C. for 2 hours. The inside was then depressurized while being heated, thereby preparing silica particles 1. Table 1 shows physical properties of the silica particles 1.

### Production Example of Silica Particles 2 to 13

Silica particles 2 to 13 with different number-average particle diameters and different hydrophobization ratios were prepared in the same manner as the silica particles 1 except that the number of parts of methanol to be charged and the type and number of parts of the surface treatment agent were changed. Table 1 shows physical properties of the fine silica particles 2 to 13.

### Production Example of Silica Particles 14

After oxygen gas is supplied to a burner to ignite an ignition burner, hydrogen gas is supplied to the burner to form a flame, and silicon tetrachloride as a raw material is charged into the flame and gasified. A flame hydrolysis reaction is then performed, and the resulting silica powder (dry silica) is recovered. The number-average particle diameter and shape of the dry silica can be arbitrarily adjusted by appropriately changing the flow rate of silicon tetrachloride, the supply flow rate of oxygen gas, the supply flow rate of hydrogen gas, and the residence time of silica in the flame.

The dry silica was charged into an autoclave equipped with a stirrer and was heated to 200° C. in a fluidized state by stirring. The reactor (the autoclave equipped with the stirrer) was purged with nitrogen gas and was scaled, and 25 parts of hexamethyldisilazane relative to 100 parts of the dry silica was sprayed into the reactor to perform a silane compound treatment in a fluidized state of the silica. The reaction was continued for 60 minutes and was then terminated. After completion of the reaction, the autoclave was depressurized and was purged with a nitrogen gas stream to remove an excessive amount of hexamethyldisilazane and by-products from hydrophobic silica, thereby preparing silica particles 14. Table 1 shows physical properties of the silica particles 14.

TABLE 1

| | | Number-average | Hydro- |
|---|---|---|---|
| | | particle | phobization |
| | Production | diameter | ratio |
| Silica particle | method | (nm) | (%) |
| Silica particles 1 | Wet process | 100 | 97 |
| Silica particles 2 | Wet process | 100 | 95 |
| Silica particles 3 | Wet process | 100 | 98 |
| Silica particles 4 | Wet process | 60 | 93 |
| Silica particles 5 | Wet process | 225 | 99 |
| Silica particles 6 | Wet process | 250 | 99 |
| Silica particles 7 | Wet process | 50 | 99 |
| Silica particles 8 | Wet process | 40 | 99 |
| Silica particles 9 | Wet process | 260 | 99 |
| Silica particles 10 | Wet process | 40 | 93 |
| Silica particles 11 | Wet process | 40 | 85 |
| Silica particles 12 | Wet process | 40 | 93 |
| Silica particles 13 | Wet process | 260 | 93 |
| Silica particles 14 | Dry process | 40 | 99 |

### Production Example of Magnetic Core Particles 1

### Step 1 (Weighing and Mixing Step)

Ferrite raw materials were weighed to satisfy the following.
Fe₂O₃: 68.3%
MnCO₃: 28.5%
Mg(OH)₂: 2.0%
SrCO₃: 1.2%

20 parts of distilled water was then added to 80 parts of a mixture of the ferrite raw materials, and the mixture was pulverized and mixed in a ball mill using zirconia balls (φ10 mm) for 3 hours to prepare a slurry.

### Step 2 (Preliminary Calcination Step)

The slurry was dried with a spray dryer (manufactured by Ohkawara Kakohki Co., Ltd.) and was calcined in a batch-type electric furnace in a nitrogen atmosphere (oxygen concentration: 1.0% by volume) at a temperature of 1050° C. for 3.0 hours to prepare a pre-calcined ferrite.

### Step 3 (Pulverization Step)

The pre-calcined ferrite was pulverized to approximately 0.5 mm with a crasher and was then pulverized for 3 hours with a wet bead mill using ⅛-inch stainless steel beads. It was further pulverized in a wet ball mill using zirconia balls (φ1.0 mm) for 4 hours to prepare a pre-calcined ferrite slurry.

### Step 4 (Granulation Step)

1.0 part of ammonium polycarboxylate and 1.5 parts of poly(vinyl alcohol) were added to 100 parts of the pre-calcined ferrite slurry, and the slurry was granulated into spherical particles of 37 μm using a spray dryer (manufactured by Ohkawara Kakohki Co., Ltd.). The granulated product was heated in a rotary electric furnace at 700° C. for 2 hours.

### Step 5 (Main Calcination Step)

In a nitrogen atmosphere (oxygen concentration: 1.0% by volume), the time from room temperature to the calcination temperature (1100° C.) was set to 2 hours, and the temperature was held at 1100° C. for 4 hours for calcination. The temperature was then lowered to 60° C. over 8 hours, the nitrogen atmosphere was returned to the air, and the product was taken out at a temperature of 40° C. or less.

### Step 6 (Sorting Step)

The agglomerate was crushed, coarse particles were removed by sieving with a sieve with an aperture of 150 μm, and a fine powder was removed by air classification. Furthermore, a low magnetic force component was removed by magnetic separation to prepare magnetic core particles 1. The shape of the magnetic core particles was observed with a scanning electron microscope SU8220 (manufactured by Hitachi High-Tech Corporation), and it was observed that they were porous and had pores.

### Production Example of Magnetic Core Particles 2 to 5

Magnetic core particles 2 to 5 were prepared in the same manner as the magnetic core particles 1 except that the component ratio of the ferrite raw materials and the oxygen concentration in the atmosphere during calcination were changed.

### Production Example of Magnetic Core Particles 1 Filled with Silicone Resin

100.0 parts of the magnetic core particles 1 were placed in a stirring vessel of a mixing stirrer (universal stirrer NDMV type manufactured by Dalton Corporation), and the stirring vessel was purged with nitrogen gas while maintaining the temperature at 60° C. and reducing the pressure to 2.3 kPa. 10.0 parts of a silicone resin (trade name: SR2410, manufactured by Dow Corning Toray), 89.9 parts of toluene, and 0.1 parts of titanium n-butoxide were mixed and stirred with a multi-blender mixer for 10 minutes. The resulting silicone resin solution was added dropwise into the stirring vessel under reduced pressure while stirring in the stirring vessel. The dropping amount was set to 7.5 parts as a resin component. After completion of the dropwise addition, stirring was continued for 2 hours. Furthermore, the temperature was increased to 70° C., and the solvent was removed under reduced pressure to fill the pores inside the magnetic core particles with the silicone resin composition and apply the silicone resin composition to the surface of the magnetic core particles. After cooling, the resulting particles were transferred to a mixer (drum mixer UD-AT type manufactured by Sugiyama Heavy Industrial Co., Ltd.) with a spiral blade in a rotatable mixing vessel and were heated to 220° C. at a heating rate of 2° C./min in a nitrogen atmosphere and at atmospheric pressure. The product was heated with stirring at this temperature for 60 minutes to cure the silicone resin. After the curing treatment, a low magnetic force product was separated by magnetic separation, and carrier core particles 1 filled with the silicone resin were prepared by classification with a sieve with an aperture of 150 μm.

### Production Example of Resin Coating Liquid

80 parts of cyclohexyl methacrylate and 20 parts of methyl methacrylate were added to a four-neck flask equipped with a reflux condenser, a thermometer, a nitrogen inlet tube, and a shear type stirrer.

Furthermore, 100 parts of toluene, 100 parts of methyl ethyl ketone, and 2.0 parts of azobisisovaleronitrile were added thereto. The resulting mixture was kept in a nitrogen stream at 70° C. for 10 hours to perform polymerization. After completion of the polymerization reaction, hexane was poured to deposit and precipitate a copolymer, and the precipitate was separated by filtration and was then dried under vacuum to prepare a covering resin.

Toluene and methyl ethyl ketone were added to the covering resin at a ratio of 1:1 so that the solid content was 5%, thereby preparing a covering resin solution (solid content: 5%). Furthermore, 25 parts of the silica particles 1 were added to 2,000 parts of the covering resin solution (resin solid content: 100 parts), and the resulting mixture was shaken and stirred for 15 minutes using a paint shaker (manufactured by RADIA) to prepare a resin coating liquid 1.

### Production Example of Magnetic Carrier 1

Magnetic core particles 1 filled with silicone resin: 100 parts
Resin coating liquid 1:40 parts

These materials were charged into a planetary mixer (Nauta mixer VN-TYPE manufactured by Hosokawa Micron Corporation) maintained under reduced pressure (1.5 kPa) at a temperature of 60° C. First, the whole amount of the magnetic core particles filled with the silicone resin was added, then one third of the amount of the resin coating liquid 1 was added, and solvent removal and application was performed for 20 minutes. One third of the amount of the resin coating liquid 1 was then added, solvent removal and application was performed for 20 minutes, one third of the amount of the resin coating liquid 1 was added, and solvent removal and application was performed for 20 minutes.

A magnetic carrier covered with the covering resin composition was then transferred to a mixer with a spiral blade in a rotatable mixing vessel (a drum mixer UD-AT type manufactured by Sugiyama Heavy Industrial Co., Ltd.). It was heat-treated in a nitrogen atmosphere at a temperature of 120° C. for 2 hours while stirring by rotating the mixing vessel 10 times per minute. The resulting magnetic carrier was subjected to magnetic separation to separate a low magnetic force product, was passed through a sieve with an aperture of 150 μm, and was then classified with an air classifier to prepare a magnetic carrier 1. Table 2-2 shows physical properties of the magnetic carrier 1.

### Production Example of Magnetic Carriers 2 to 25

Magnetic carriers 2 to 25 were prepared in the same manner as the magnetic carrier 1 except that the type of magnetic core particles, the type and number of parts of silica particles, the number of parts of resin coating liquid, and the coating process were changed as shown in Table 2-1. Table 2-2 shows physical properties of the magnetic carriers 2 to 25.

TABLE 2-1

| | Formulation | | | | | |
|---|---|---|---|---|---|---|
| | | Silica particles | | | | |
| | | | Number- | | Resin coating | |
| | Type of | | average | | liquid | |
| | magnetic | | particle | Hydrophobization | Addition | Addition |
| | core | | diameter | ratio | amount | amount |
| | particle | Type | (nm) | (%) | (parts) | (parts) |
| Magnetic | 1 | 1 | 100 | 97 | 25 | 40 |
| carrier 1 | | | | | | |
| Magnetic | 1 | 2 | 100 | 95 | 25 | 40 |
| carrier 2 | | | | | | |
| Magnetic | 1 | 3 | 100 | 98 | 25 | 40 |
| carrier 3 | | | | | | |
| Magnetic | 1 | 4 | 60 | 93 | 25 | 40 |
| carrier 4 | | | | | | |
| Magnetic | 1 | 5 | 225 | 99 | 25 | 40 |
| carrier 5 | | | | | | |
| Magnetic | 1 | 6 | 250 | 99 | 25 | 40 |
| carrier 6 | | | | | | |
| Magnetic | 1 | 6 | 250 | 99 | 25 | 40 |
| carrier 7 | | | | | | |
| Magnetic | 1 | 7 | 50 | 99 | 40 | 40 |
| carrier 8 | | | | | | |
| Magnetic | 1 | 6 | 250 | 99 | 20 | 40 |
| carrier 9 | | | | | | |
| Magnetic | 1 | 8 | 40 | 99 | 40 | 40 |
| carrier 10 | | | | | | |
| Magnetic | 1 | 9 | 260 | 99 | 20 | 40 |
| carrier 11 | | | | | | |
| Magnetic | 1 | 9 | 260 | 99 | 16 | 40 |
| carrier 12 | | | | | | |
| Magnetic | 1 | 10 | 40 | 93 | 45 | 40 |
| carrier 13 | | | | | | |
| Magnetic | 2 | 10 | 40 | 93 | 45 | 40 |
| carrier 14 | | | | | | |
| Magnetic | 3 | 10 | 40 | 93 | 45 | 40 |
| carrier 15 | | | | | | |
| Magnetic | 3 | 10 | 40 | 93 | 50 | 45 |
| carrier 16 | | | | | | |
| Magnetic | 3 | 10 | 40 | 93 | 40 | 30 |
| carrier 17 | | | | | | |
| Magnetic | 1 | 11 | 40 | 85 | 45 | 40 |
| carrier 18 | | | | | | |
| Magnetic | 1 | 14 | 40 | 99 | 45 | 40 |
| carrier 19 | | | | | | |
| Magnetic | 1 | 12 | 40 | 93 | 45 | 40 |
| carrier 20 | | | | | | |
| Magnetic | 1 | 13 | 260 | 93 | 16 | 40 |
| carrier 21 | | | | | | |
| Magnetic | 4 | 12 | 40 | 93 | 45 | 40 |
| carrier 22 | | | | | | |
| Magnetic | 5 | 12 | 40 | 93 | 45 | 40 |
| carrier 23 | | | | | | |
| Magnetic | 1 | 12 | 40 | 93 | 45 | 55 |
| carrier 24 | | | | | | |
| Magnetic | 1 | 12 | 40 | 93 | 45 | 20 |
| carrier 25 | | | | | | |

TABLE 2-2

| | Physical properties | | | | | | | |
|---|---|---|---|---|---|---|---|---|
| | | | | | A | | H/A | rA/A |
| | Ra | σS | H | M | (% by | rA | (nm/% by | (nm/% by |
| | (μm) | (Am²/kg) | (nm) | (mg) | area) | (nm) | area) | area) |
| Magnetic | 0.45 | 50 | 60 | 0.80 | 15 | 100 | 4.00 | 6.67 |
| carrier 1 | | | | | | | | |
| Magnetic | 0.45 | 50 | 60 | 0.90 | 15 | 100 | 4.00 | 6.67 |
| carrier 2 | | | | | | | | |
| Magnetic | 0.45 | 50 | 60 | 0.75 | 15 | 100 | 4.00 | 6.67 |
| carrier 3 | | | | | | | | |
| Magnetic | 0.45 | 50 | 35 | 1.00 | 15 | 60 | 2.33 | 4.00 |
| carrier 4 | | | | | | | | |
| Magnetic | 0.45 | 50 | 60 | 0.75 | 15 | 225 | 4.00 | 15.00 |
| carrier 5 | | | | | | | | |
| Magnetic | 0.45 | 50 | 35 | 0.70 | 15 | 250 | 2.33 | 16.67 |
| carrier 6 | | | | | | | | |
| Magnetic | 0.45 | 50 | 90 | 0.80 | 15 | 250 | 6.00 | 16.67 |
| carrier 7 | | | | | | | | |
| Magnetic | 0.45 | 50 | 35 | 0.80 | 30 | 50 | 1.17 | 1.67 |
| carrier 8 | | | | | | | | |
| Magnetic | 0.45 | 50 | 90 | 0.70 | 10 | 250 | 9.00 | 25.00 |
| carrier 9 | | | | | | | | |
| Magnetic | 0.45 | 50 | 25 | 0.75 | 30 | 40 | 0.83 | 1.33 |
| carrier 10 | | | | | | | | |
| Magnetic | 0.45 | 50 | 100 | 0.85 | 10 | 260 | 10.00 | 26.00 |
| carrier 11 | | | | | | | | |
| Magnetic | 0.45 | 50 | 100 | 0.60 | 7 | 260 | 14.29 | 37.14 |
| carrier 12 | | | | | | | | |
| Magnetic | 0.45 | 50 | 25 | 1.10 | 35 | 40 | 0.71 | 1.14 |
| carrier 13 | | | | | | | | |
| Magnetic | 0.45 | 45 | 25 | 1.10 | 35 | 40 | 0.71 | 1.14 |
| carrier 14 | | | | | | | | |
| Magnetic | 0.45 | 60 | 25 | 1.10 | 35 | 40 | 0.71 | 1.14 |
| carrier 15 | | | | | | | | |
| Magnetic | 0.35 | 60 | 25 | 1.10 | 35 | 40 | 0.71 | 1.14 |
| carrier 16 | | | | | | | | |
| Magnetic | 0.55 | 60 | 25 | 1.10 | 35 | 40 | 0.71 | 1.14 |
| carrier 17 | | | | | | | | |
| Magnetic | 0.45 | 50 | 25 | 1.50 | 35 | 40 | 0.71 | 1.14 |
| carrier 18 | | | | | | | | |
| Magnetic | 0.45 | 50 | 25 | <0.1 | 35 | 40 | 0.71 | 1.14 |
| carrier 19 | | | | | | | | |
| Magnetic | 0.45 | 50 | 20 | 1.05 | 35 | 40 | 0.57 | 1.14 |
| carrier 20 | | | | | | | | |
| Magnetic | 0.45 | 50 | 120 | 0.90 | 6 | 260 | 20.00 | 43.33 |
| carrier 21 | | | | | | | | |
| Magnetic | 0.45 | 40 | 25 | 1.10 | 35 | 40 | 0.71 | 1.14 |
| carrier 22 | | | | | | | | |
| Magnetic | 0.45 | 70 | 25 | 1.10 | 35 | 40 | 0.71 | 1.14 |
| carrier 23 | | | | | | | | |
| Magnetic | 0.20 | 50 | 25 | 1.10 | 31 | 40 | 0.81 | 1.29 |
| carrier 24 | | | | | | | | |
| Magnetic | 0.80 | 50 | 25 | 1.10 | 40 | 40 | 0.63 | 1.00 |
| carrier 25 | | | | | | | | |

### Production Example of Two-Component Developer 1

10 parts of the toner 1 was added to 90 parts of the magnetic carrier 1 and was mixed for 5 minutes in a V-type mixer (V-20, manufactured by Seishin Enterprise Co., Ltd.) to prepare a two-component developer 1.

### Production Example of Two-Component Developers 2 to 25

Two-component developers 2 to 25 were prepared in the same manner as in the production example of the two-component developer 1 except that the magnetic carrier was changed as shown in Table 3.

TABLE 3

| Two-component | Magnetic | |
|---|---|---|
| developer | carrier | Toner |
| Type | Type | Type |
| 1 | 1 | 1 |
| 2 | 2 | 1 |
| 3 | 3 | 1 |
| 4 | 4 | 1 |
| 5 | 5 | 1 |
| 6 | 6 | 1 |
| 7 | 7 | 1 |
| 8 | 8 | 1 |
| 9 | 9 | 1 |
| 10 | 10 | 1 |
| 11 | 11 | 1 |
| 12 | 12 | 1 |
| 13 | 13 | 1 |
| 14 | 14 | 1 |
| 15 | 15 | 1 |
| 16 | 16 | 1 |
| 17 | 17 | 1 |
| 18 | 18 | 1 |
| 19 | 19 | 1 |
| 20 | 20 | 1 |
| 21 | 21 | 1 |
| 22 | 22 | 1 |
| 23 | 23 | 1 |
| 24 | 24 | 1 |
| 25 | 25 | 1 |

### Evaluation

A full-color copying machine imagePRESS V1000 manufactured by CANON KABUSHIKI KAISHA was modified so as to be able to output an image only with a development unit at a cyan position. Furthermore, the development contrast was made adjustable to an arbitrary value, and the machine was modified so that the automatic correction of the image density by the main body did not operate. The image-forming speed was set to 100 sheets/minute. The two-component developer was placed in the development unit at the cyan position to output an image, and various evaluations were performed while performing a durability test. A4-size GFC-081 (81.0 g/m²) (Canon Marketing Japan Inc.) was used as an evaluation paper.

### (1) Evaluation of Image Reproducibility

An image with a printing rate of 40% was output on 50,000 sheets (A4 landscape) in a high-temperature and high-humidity environment (30° C., 80% RH). A halftone image (A4 landscape, 30H) was then output on one sheet. The 30H image is a halftone image in which 256 gray levels are expressed in hexadecimal number, 00H represents solid white (non-image), and FFH represents solid black (full-surface image). The dot area in the halftone image was measured, and the variation in the dot area was quantified to evaluate the image reproducibility (hereinafter, a dot reproducibility index (I)).

The dot reproducibility index (I) was calculated as described below. The area of 1000 dots in the halftone image was measured with a digital microscope VHX-500 (a lens wide range zoom lens VH-Z100, manufactured by Keyence Corporation). The dot reproducibility index (I) was calculated from the obtained number average (S) and standard deviation (σ) of the dot area using the following formula, and the image reproducibility was evaluated according to the following criteria. Table 4 shows the evaluation results of the two-component developers 1 to 25.

$$Dot reproducibility index ( I ) = σ / S \times 100$$

A: Dot reproducibility index (I) of less than 4.0
B: Dot reproducibility index (I) of 4.0 or more and less than 6.0
C: Dot reproducibility index (I) of 6.0 or more and less than 8.0
D: Dot reproducibility index (I) of 8.0 or more

### (2) Evaluation of Ghost

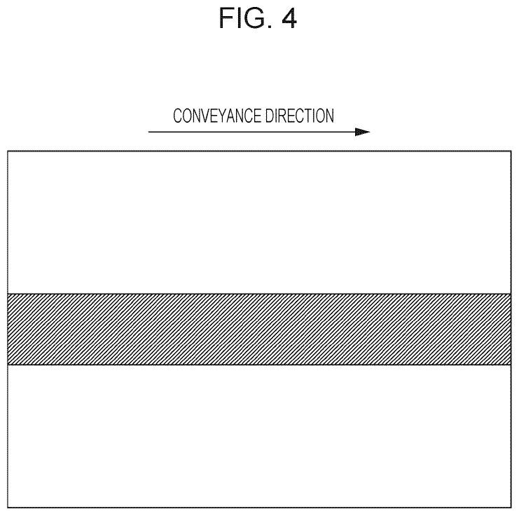

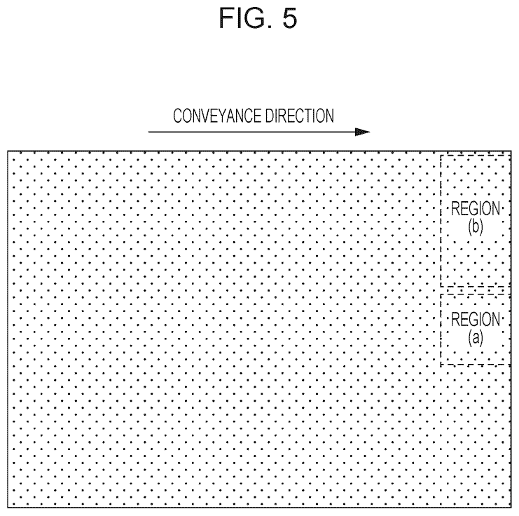

The two-component developer was placed in the development unit at the cyan position and was then left to stand in a high-temperature and high-humidity environment (30° C., 80% RH) for 24 hours. The two-component developer was then idly rotated in the development unit to charge the toner. The amount of the two-component developer on a developing sleeve serving as a developer carrier was adjusted to 30 mg/cm², and the distance between the developing sleeve and an electrostatic latent image bearing member was adjusted to 260 μm. The development contrast was adjusted so that a full-surface solid fill image (FFH) had an image density of 1.45. After the image contrast was adjusted, a tone at which a full-surface halftone image had an image density of 0.40±0.03 was specified. An image including a transverse band of a solid portion and a solid white portion other than the transverse band illustrated in FIG. 4 was output on one sheet (A4 landscape), and a full-surface halftone image having a tone with an image density of 0.40±0.03 illustrated in FIG. 5 was then output on one sheet (A4 landscape).

A region (a) in FIG. 5 is a region corresponding to the transverse band of the solid portion in FIG. 4. A region (b) in FIG. 5 is a region corresponding to the solid white region in FIG. 4. The regions (a) and (b) in FIG. 5 were divided into three areas in the transverse direction of the evaluation paper to measure the image density of the central portion of each area using a spectrodensitometer 500 series (manufactured by X-Rite, Inc.). The density difference ratio (%) was calculated using the following formula, wherein OD(a) denotes the average value of the image density of the region (a), and OD(b) denotes the average value of the image density of the region (b), and the ghosting was evaluated according to the following criteria. The widths of the region (a) and the region (b) in the longitudinal direction of the evaluation paper are equal to the circumferential length (62.8 mm) of the developing sleeve.

$$Density difference ratio ( \% ) = \{ OD ( b ) - OD ( a ) \} / OD ( a ) \times 100$$

Subsequently, a durability image (A4 landscape, 5% printing rate) was output on 270,000 sheets, and the ghosting was then evaluated in the same manner as described above. Table 4 shows the evaluation results of the two-component developers 1 to 25.
A: less than 1.0%
B: 1.0% or more and less than 2.0%
C: 2.0% or more and less than 3.0%
D: 3.0% or more and less than 4.0%
E: 4.0% or more and less than 5.0%
F: 5.0% or more and less than 6.0%
G: 6.0% or more

TABLE 4

| | | Evaluation of image | | Evaluation of ghost | | | |
|---|---|---|---|---|---|---|---|
| | | reproducibility | | | | After durability | |
| | Two-component | Dot | | Initial | | test | |
| | developer | reproducibility | | Density | | Density | |
| | Type | index (I) | Rank | difference (%) | Rank | difference (%) | Rank |
| Example 1 | 1 | 2.0 | A | 0.2% | A | 0.5% | A |
| Example 2 | 2 | 2.0 | A | 0.3% | A | 1.2% | B |
| Example 3 | 3 | 2.0 | A | 0.5% | A | 1.4% | B |
| Example 4 | 4 | 2.0 | A | 0.7% | A | 2.2% | C |
| Example 5 | 5 | 2.0 | A | 0.8% | A | 2.4% | C |
| Example 6 | 6 | 2.0 | A | 1.3% | B | 2.8% | C |
| Example 7 | 7 | 2.0 | A | 1.2% | B | 2.6% | C |
| Example 8 | 8 | 2.0 | A | 1.6% | B | 3.2% | D |
| Example 9 | 9 | 2.0 | A | 1.7% | B | 3.3% | D |
| Example 10 | 10 | 2.0 | A | 2.2% | C | 3.6% | D |
| Example 11 | 11 | 2.0 | A | 2.4% | C | 3.8% | D |
| Example 12 | 12 | 2.0 | A | 2.8% | C | 4.3% | F |
| Example 13 | 13 | 2.0 | A | 2.7% | C | 4.2% | F |
| Example 14 | 14 | 4.0 | B | 2.8% | C | 4.3% | E |
| Example 15 | 15 | 5.0 | B | 2.7% | C | 4.2% | F |
| Example 16 | 16 | 5.0 | B | 3.4% | D | 4.8% | E |
| Example 17 | 17 | 7.0 | C | 3.3% | D | 4.7% | E |
| Comparative | 18 | 2.0 | A | 3.5% | D | 5.3% | F |
| example 1 | | | | | | | |
| Comparative | 19 | 2.0 | A | 4.6% | E | 5.8% | F |
| example 2 | | | | | | | |
| Comparative | 20 | 2.0 | A | 3.7% | D | 5.5% | F |
| example 3 | | | | | | | |
| Comparative | 21 | 2.0 | A | 3.6% | D | 5.6% | F |
| example 4 | | | | | | | |
| Comparative | 22 | 1.0 | A | 3.2% | D | 4.8% | E |
| example 5 | | | | | | | |
| Comparative | 23 | 10.0 | D | 2.3% | C | 3.8% | D |
| example 6 | | | | | | | |
| Comparative | 24 | 2.0 | A | 5.0% | F | 6.3% | G |
| example 7 | | | | | | | |
| Comparative | 25 | 2.0 | A | 5.2% | F | 6.6% | G |
| example 8 | | | | | | | |

The present disclosure can achieve both the suppression of the ghosting in a high-temperature and high-humidity environment and high image reproducibility.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-156490, filed Sep. 10, 2024, which is hereby incorporated by reference herein in its entirety.

What is claimed is:

1. A magnetic carrier comprising:
a magnetic carrier particle that has a magnetic core particle and has a covering resin layer covering a surface of the magnetic core particle,
wherein a surface of the magnetic carrier particle has an arithmetic average roughness Ra (μm) satisfying formula (1):
$$0.3 \leq Ra \leq 0.6 \qquad ( 1 )$$
the magnetic carrier has an intensity of magnetization σS (Am²/kg) in a magnetic field of 796 kA/m satisfying formula (2):
$$45 \leq σ S \leq 60 \qquad ( 2 )$$
the covering resin layer contains silica particles, and at least part of the silica particles are exposed on the surface of the magnetic carrier particle,
when an average value H (nm) of protrusion heights of the silica particles exposed on the surface of the magnetic carrier particle is calculated for the silica particles exposed on the surface of the magnetic carrier particle, H satisfies formula (3):
$$25 \leq H \leq 100 \qquad ( 3 )$$
and an amount of adsorbed water M (mg) per gram of the magnetic carrier at a temperature of 30° C. and at a relative humidity of 80% satisfies formula (4):
$$0.6 \leq M \leq 1. . \qquad ( 4 )$$

2. The magnetic carrier according to claim 1, wherein a coverage A (% by area) of the surface of the magnetic carrier particle with the silica particles satisfies formula (5):
$$10 \leq A \leq 30. \qquad ( 5 )$$

3. The magnetic carrier according to claim 1, wherein the silica particles exposed on the surface of the magnetic carrier particle have a number-average particle diameter rA (nm) satisfying formula (6):
$$50 \leq rA \leq 250. \qquad ( 6 )$$

4. The magnetic carrier according to claim 2, wherein H and A satisfy formula (7):
$$2.3 \leq H / A \leq 6. . \qquad ( 7 )$$

5. The magnetic carrier according to claim 3, wherein rA and A satisfy formula (8):
$$4. \leq rA / A \leq 15. . \qquad ( 8 )$$

6. The magnetic carrier according to claim 1, wherein the silica particles are wet silica particles.

7. The magnetic carrier according to claim 1, wherein the silica particles have a hydrophobization ratio W (%) satisfying formula (9):
$$95 \leq W \leq 98. \qquad ( 9 )$$
